(19) United States
(12) Patent Application Publication
(10) Pub. No.: US 2006/0180061 A1
(43) Pub. Date: Aug. 17, 2006

(54) Hole Coring Apparatus

(76) Inventor: John Van Denham, Traralgon, Victoria (AU)

Correspondence Address: ROGER A JACKSON, ESQ, 800 PENNSYLVANIA, SUITE 1504, DENVER, CO, 80203-3185, US

(21) Appl. No.: 11/308,270

(22) Filed: Mar. 15, 2006

Related U.S. Application Data
(63) Continuation-in-part of application No. 10/908,334, filed on May 8, 2005.

(30) Foreign Application Priority Data
Nov. 9, 2004 (AU) 2004229017

(51) Int. Cl. A01C 11/00

(52) U.S. Cl. 111/100

(57) ABSTRACT

An earth hole coring apparatus and method includes a receptacle with a surrounding sidewall about an axis, with first and second open ends transverse to the axis defining a receptacle interior, and a first open end perimeter less than a second open end perimeter. A plant guide with a second end adjacent to the sidewall and a first end, positioned substantially parallel to the axis and a driving member adjacent to the plant guide and receptacle positioned substantially transverse to the axis, offset to the plant guide with a long and short extension. A handle adjacent to the plant guide is substantially transverse to the axis located between the driving member and first end, being approximately co planar to the driving member, and offset to the plant guide having a long and short extension, the handle long extension opposite the driving member long extension related to the plant guide.

### CROSS REFERENCE TO RELATED APPLICATIONS

This application is a continuation in part of U.S. patent application Ser. No. 10/908,334 filed on May 8, 2005 by John Van Denham that claims priority from Australian patent application serial number 2004229017 filed on Nov. 9, 2004 by John Van Denham.

### TECHNICAL FIELD

The present invention relates to an apparatus for creating holes in an earth surface for the purpose of transplanting plants from pots into the earth. More particularly, the present invention is a manual hole coring apparatus that utilizes counterbalancing forces from the operators hands and feet to increase the downward force that the operator can exert upon the apparatus into the earth's surface without the operator having to remove a foot from the earth's surface to enhance the operators stability.

### BACKGROUND OF INVENTION

The transplanting of plants from smaller pots of diameters that are in the approximate range of two to ten inches normally requires a hole to be bored, cord, or dug in the earth surface of a slightly greater diameter than that of the pot and up to a depth of approximately ten inches. In a domestic situation the number of plantings required are relatively few and normally the holes are dug by means of a shovel or spade. If the earth is particularly difficult to dig because of stones or the earth composition or condition, a pick, mattock, or crowbar may be necessary to form the hole. This can be inconvenient and an apparatus that can form holes in such difficult earth would be desirable. Furthermore, when plantings are undertaken on a larger commercial scale as in the forestry industry, a more convenient and efficient hole creating apparatus is desirable.

It has long been recognized in the prior art, the benefits of using a hole coring type of apparatus for creating holes in the earth surface for the purpose of transplanting plants from pots into the earth. A hole coring apparatus typically includes a hollowed tapered cylinder that penetrates the earth's surface with the narrow end of the taper, thus there is a coring affect of the earth that is gathered on the interior of the tapered cylindrical tube. There are three primary advantages to the tapered cylindrical tube; the first one is that the core of the earth in the interior of the tapered cylindrical tube as the earth inserts into the tube interior during penetration of the earth's surface expands slightly so that when the tapered cylindrical tube is removed from the earth's surface the core of earth will be retained within the interior of the cylinder, thus creating the hole in the earth's surface. Secondly, in addition, removal of the core of earth is easier because the core has the shape of a tapered cylinder and can be extracted on the end of the tapered cylinder that is the larger diameter. Thirdly, the other advantage of the tapered cylindrical tube is that removal of the tapered cylinder itself from the earth's surface is easier because as the taper expands as the cylinder is penetrated into the earth, thereupon removal of the tapered cylinder from the earth, side friction is eliminated against the exterior of the cylinder. The reason for this is that the outside surface of the tapered cylinder has expanded the size of the hole and the earth by the penetration of the cylinder to a diameter larger than the outside diameter of the tapered cylinder being removed. This is as compared to a straight sided cylinder that once penetrated into the earth's surface can be quite difficult to remove due to the high degree of friction of the earth against the outside diameter of the cylinder. Thus, do the due to the advantages of the hole coring apparatus it has been widely used especially in situations where the earth is soft and a high number of cored holes are created as a typical hole coring apparatus can then easily allow a single manual operator to create about four hundred to five hundred holes in a day's time, especially as the cores are self removing as when the core is created it automatically drives out the prior core from the tapered cylinder.

A few prior art examples for a typical hole coring apparatus would be a U.S. Pat. No. 5,826,668 to Kosmalski that discloses a square cut sod turf planting tool for the purpose of removing cored square sections of sod at a selected depth. Another example would be U.S. Pat. No. 2,612,725 to Casey that discloses a forming and cutting tool for creating holes to plant bulbs and the like. Interestingly, Casey utilizes a straight cylinder upon its outside diameter with the cylinder having a tapered inside diameter which would seem to be satisfactory for holding the core on the inside of the cylinder, however, adding the problem of the difficulty in removing the straight sided cylinder from the earth as the straight sided cylinder outside diameter having the aforementioned excessive friction with the earth. Yet, another example is U.S. Pat. No. 1,952,585 to Croasdale, Jr. et al. that discloses a planting tool somewhat similar to Casey, however, using a truly tapered cylinder for creating the earth's core to create the hole in the earth's surface. Croasdale, Jr. et al. also includes a one-sided foot rest to assist in having the tapered cylinder penetrate the earth's surface. A last example would be U.S. Pat. No. 6,386,294 B1 to Best that discloses a hole making apparatus utilizing a straight cylindrical coring element with the addition of a tamper plate that is slidably engaged on the interior of the cylinder to assist in removing the soil plug from the cylinder, note that when the interior of the cylinder is straight that the earth's core can be difficult to remove from the cylinder interior.

However, there is a problem with the use of a typical hole coring apparatus, in that it requires a substantial amount of force to get the tapered cylinder to penetrate the earth's surface, and this is especially so when the earth is comprised of rocks combined with highly compact soils making for fairly hard earth, which can make penetration of the earth's surface by the tapered cylinder almost impossible. Thus, it is typically required for a manual operator to use both their feet and hands upon the a hole coring apparatus to maximize the amount of manual force that can be exerted for penetrating the surface which is going to typically be equal the operators body weight. This creates another problem in that when the operator is entirely standing upon the hole coring apparatus in an attempt to get the tapered cylinder to penetrate the earth's surface the operator places themselves into an inherently unstable position as they are virtually standing on a pogo stick type arrangement, with all their weight placed upon the leading edge of the tapered cylinder that is not anchored into the earth's surface and with no other means of lateral support for the operator to secure or stabilize themselves. This is especially troublesome with young and old operators, or operators that are not as physically fit as they could be. The instability of the operator is further aggravated by some situations where the operator would be jumping up and down upon the hole coring apparatus to gain a benefit of kinetic impact energy from their body upon the hole coring apparatus to increase the force upon the tapered cylinder into the earth's surface.

What is needed is a hole coring apparatus that incorporates all the aforementioned benefits of the tapered cylinder both for the inside and the outside of the cylinder, while at the same time overcoming the previously mentioned problem of increasing the force, of being able to penetrate the tapered cylinder into the earth's surface without causing the operator to have an unstable and unsafe situation for themselves by trying to balance their entire body weight upon the top of the hole coring apparatus or even worse at the same time jumping up and down upon the hole coring apparatus. A hole coring apparatus is needed that can utilize the operator's body weight to increase the penetrating force of the tapered cylinder on the earth's surface without the drawback of compromising safety and stability of the operator themselves in using the hole coring apparatus. In addition, to have an option for the hole coring apparatus to position the plant to be disposed within the hole without the need of the operator to bend over to be close to the earth to manually position the plant within the hole would be desirable.

### SUMMARY OF INVENTION

Broadly, the present invention of a hole coring apparatus for creating a desired void in an earth surface comprises an open receptacle having a longitudinal axis, the open receptacle including a surrounding sidewall positioned substantially symmetrical about the axis. The sidewall has a first open end and a second open end that are substantially transverse to the axis to define a receptacle interior, with the first open end having a perimeter that is less than a second open end perimeter. Also included is a plant guide member extending from a second end portion being adjacent to an exterior of the sidewall to a first end portion, with the plant guide member being substantially parallel to the axis. Further included is a driving member adjacent to the plant guide member positioned substantially transverse to the axis near the receptacle, the driving member is offset in relation to the plant guide member by having a driving member long extension and an opposing driving member short extension, wherein the driving member long extension is longer than the driving member short extension.

Finally included is a handle adjacent to the plant guide member positioned substantially transverse to the axis located between the driving member and the first end portion of the plant guide member. The handle is approximately co planar with the driving member, the handle is offset in relation to the plant guide member having a handle long extension and an opposing handle short extension, wherein the handle long extension is longer than the handle short extension such that the handle long extension is placed opposite of the driving member long extension in relation to the plant guide member.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of a hole coring apparatus assembly;

FIG. 2 shows a perspective view of an open receptacle with a substantially square sidewall;

FIG. 3 shows a perspective view of an open receptacle with a substantially circular sidewall;

FIG. 4 shows a perspective view of an open receptacle with a substantially rectangular sidewall;

FIG. 5 shows a perspective view of an open receptacle with a substantially elliptical sidewall;

FIG. 6 shows a perspective view of an operator using the hole coring apparatus assembly at initial penetration of an earth surface;

FIG. 7 shows a perspective view of the operator using the hole coring apparatus assembly after full penetration of the earth surface utilizing a single operator foot;

FIG. 8 shows a perspective view of the operator using the hole coring apparatus assembly after full penetration of the earth surface utilizing both of the operator's feet;

FIG. 9 shows a perspective view of the hole coring apparatus assembly removed from the earth after full penetration of the earth surface with the hole coring apparatus assembly substantially retaining a cored earth plug;

FIG. 10 shows a perspective view of a hole coring apparatus assembly with a plant guide member and extension member;

FIG. 11 shows a reverse rear perspective view in relation to FIG. 10, of the hole coring apparatus assembly with the plant guide member;

FIG. 12 shows the same view as FIG. 11, however, with a cutaway of a second end portion of the plant guide member to show a driving member aperture and a plant guide member outlet;

FIG. 13 shows a perspective view of the operator using the hole coring apparatus assembly with the plant guide member at initial penetration of an earth surface;

FIG. 14 shows a perspective view of the operator using the hole coring apparatus assembly with the plant guide member after full penetration of the earth surface utilizing a single operator foot;

FIG. 15 shows a perspective view of the operator using the hole coring apparatus assembly with the plant guide member after full penetration of the earth surface utilizing both of the operator's feet;

FIG. 16 shows a perspective view of the hole coring apparatus assembly with the plant guide member, removed from the earth after full penetration of the earth surface with the hole coring apparatus assembly with the plant guide member, substantially retaining a cored earth plug;

FIG. 17 shows the same view as FIG. 12, however, being a use drawing showing a plant and a direction of plant movement into, through, and out of the plant guide member, with a cutaway of the second end portion of the plant guide member to show the driving member aperture and the plant guide member outlet, thus facilitating the ultimate destination of the plant into the cored hole, with the operator removed for view clarity; and

FIG. 18 shows a perspective view of a hole coring apparatus assembly with a plant guide member.

### REFERENCE NUMBERS IN DRAWINGS

20 Hole coring apparatus assembly
21 Proximal end of extension member 22
22 Extension member
23 Distal end of extension member 22
24 Driving member
25 Length of extension member 22
26 Handle
27 Interior of open receptacle 28
28 Open receptacle
29 Longitudinal axis of open receptacle 28
30 Surrounding sidewall of open receptacle 28
31 Surrounding sidewall of substantially elliptical open receptacle 28
32 Hole or void cored in earth 38
33 Surrounding sidewall of substantially rectangular open receptacle 28
34 Plug of cored earth 38
35 Surrounding sidewall of substantially square open receptacle 28
36 Surface of earth 38
37 Surrounding sidewall of substantially circular open receptacle 28
38 Earth
39 Substantially square surrounding sidewall 35 height of open receptacle 28
40 Depth of cored earth 38 hole
41 Substantially square receptacle second open end width of open receptacle 28
42 Width of cored earth 38 hole
43 First open end width of substantially square open receptacle 28
44 Operator
45 Thickness of substantially square surrounding sidewall 35 of open receptacle 28
46 Left hand of operator 44
48 Right hand operator 44
50 Left foot of operator 44
52 Right foot of operator 44
54 Total downward force
56 Right foot downward force of operator 44
58 Left hand downward force of operator 44
59 Overlap of surrounding sidewall 30 of open receptacle 28
60 First open end of open receptacle 28
61 Second open end of open receptacle 28
62 First open end perimeter of open receptacle 28
63 Second open end perimeter of open receptacle 28
64 Total upward force
65 Exterior of surrounding sidewall 30 of open receptacle 28
66 Long extension of driving member 24
67 Leading edge blade of surrounding sidewall 30 of open receptacle 28
68 Short extension of driving member 24
70 Long extension of handle 26
72 Short extension of handle 26
74 Moment of operator 44 right foot 52 at extension member 22/driving member 24 or driving member 121 interface
76 Moment of operator 44 left hand 46 at extension member 22/handle 26 interface
80 Height of substantially circular surrounding sidewall 37 of open receptacle 28
82 Second open end diameter of substantially circular surrounding sidewall 37 of open receptacle 28
84 First open end diameter of substantially circular surrounding sidewall 37 of open receptacle 28
86 Thickness of substantially circular surrounding sidewall 37 of open receptacle 28
88 Height of substantially rectangular surrounding sidewall 33 of open receptacle 28
90 Second open end width of substantially rectangular surrounding sidewall 33 of open receptacle 28
92 Second open end length of substantially rectangular surrounding sidewall 33 of open receptacle 28
94 First open end width of substantially rectangular surrounding sidewall 33 of open receptacle 28
96 First open end length of substantially rectangular surrounding sidewall 33 of open receptacle 28
97 Thickness of substantially rectangular surrounding sidewall 33 of open receptacle 28
98 Height of substantially elliptical surrounding sidewall 31 of open receptacle 28
100 Second open end major diameter of substantially elliptical surrounding sidewall 31 of open receptacle 28
101 Second open end minor diameter of substantially elliptical surrounding sidewall 31 of open receptacle 28
102 First open end major diameter of substantially elliptical surrounding sidewall 31 of open receptacle 28
103 First open end minor diameter of substantially elliptical surrounding sidewall 31 of open receptacle 28
104 Thickness of substantially elliptical surrounding sidewall 31 of open receptacle 28
108 Hole coring apparatus assembly with plant guide member 110 and extension member
109 Hole coring apparatus assembly with plant guide member 110 without extension member 22
110 Plant guide member
112 First end portion of plant guide member 110
114 Second end portion of plant guide member 110
115 Surrounding sidewall of plant guide member 110
116 Interior or chute interior of plant guide member 110
117 Width dimension of plant guide member 110
118 Inlet of plant guide member 110
119 Thickness of surrounding sidewall 115 of plant guide member 110
120 Outlet of plant guide member 110
121 Driving member with plant guide member 110 aperture 122
122 Aperture of driving member 121
123 Long extension of driving member 121 with aperture 122
124 Length of plant guide member 110
125 Short extension of driving member 121 with aperture 122
128 Handle for hole coring apparatus assembly 109
130 Long extension of handle 128
132 Short extension of handle 128
134 Right foot moment of operator 44 at plant guide member 110/driving member 121 interface
136 Left hand moment of operator 44 at plant guide member 110/handle 128 interface
148 Movement of a transplanted plant 150 into, through, and out of the plant guide member 110 into the cored earth 38 hole 32
150 Transplanted plant

### DETAILED DESCRIPTION

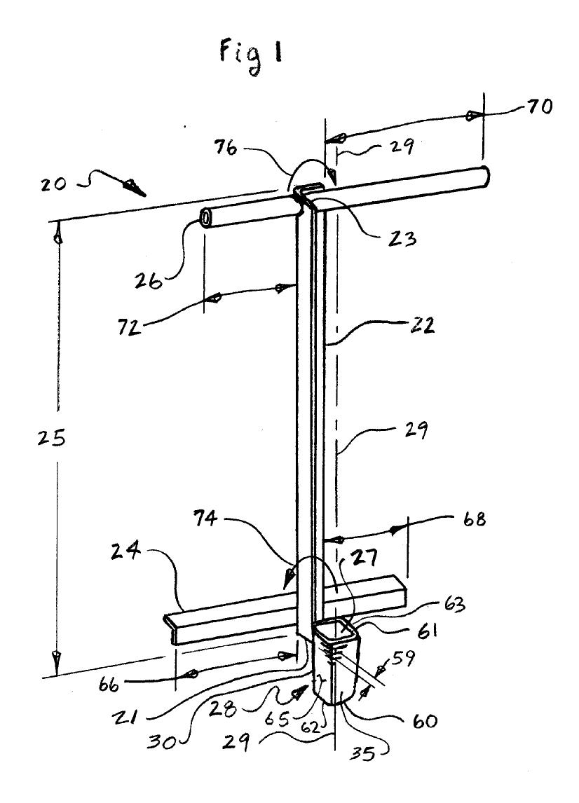

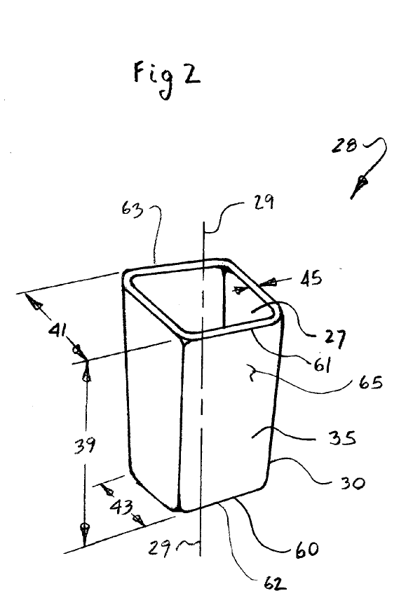

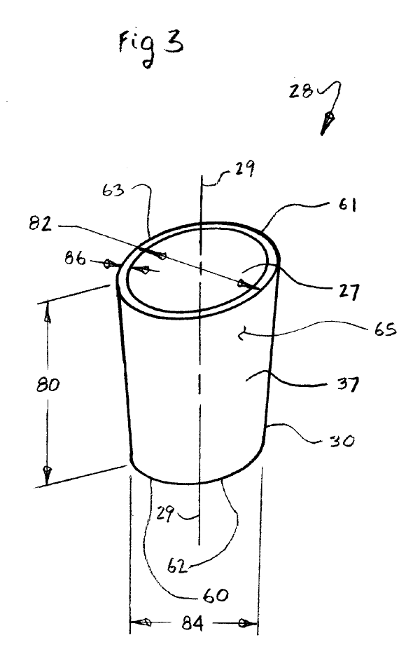

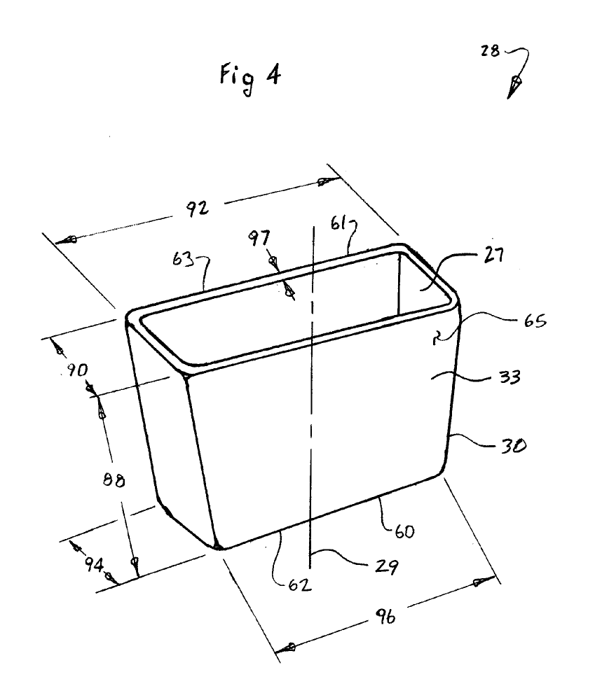

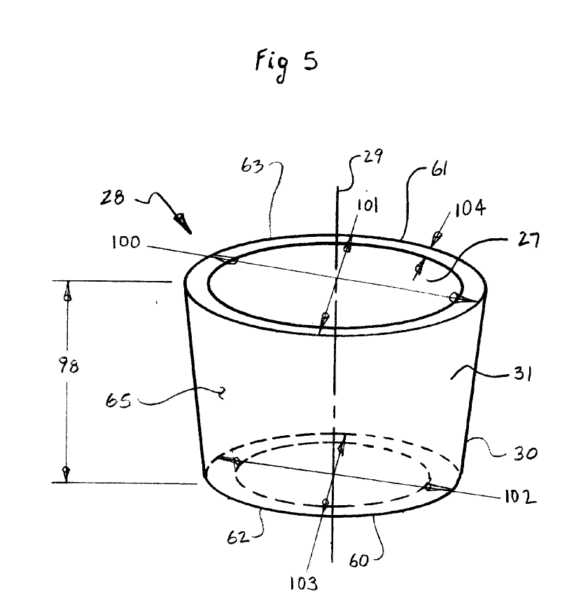

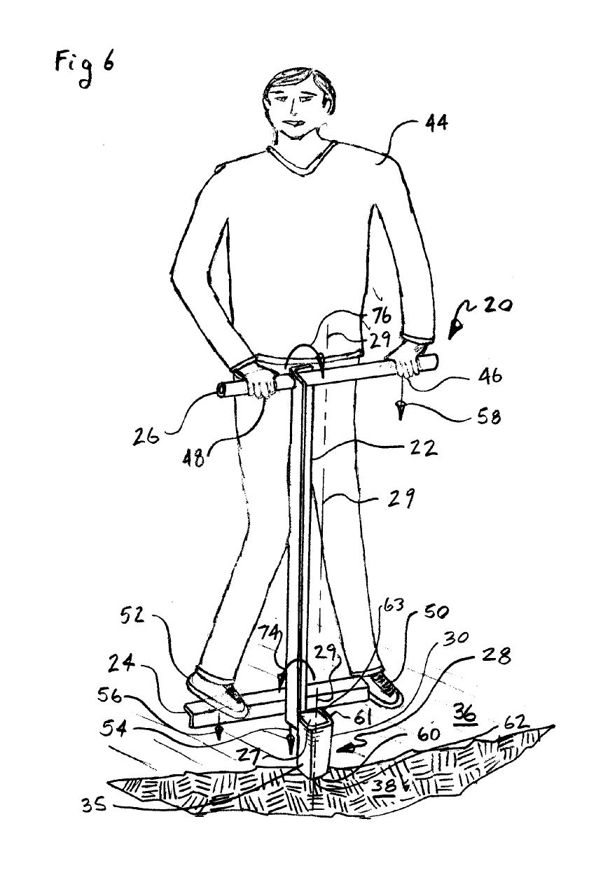

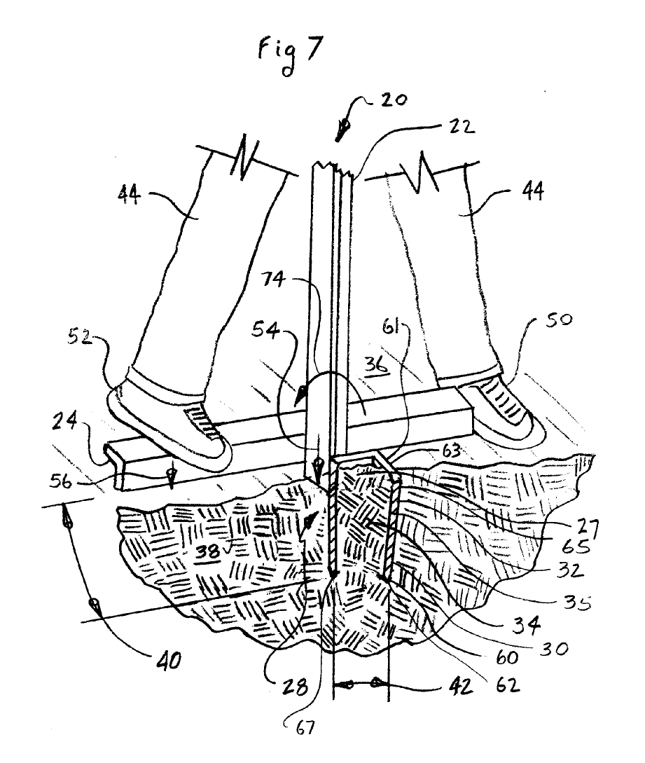

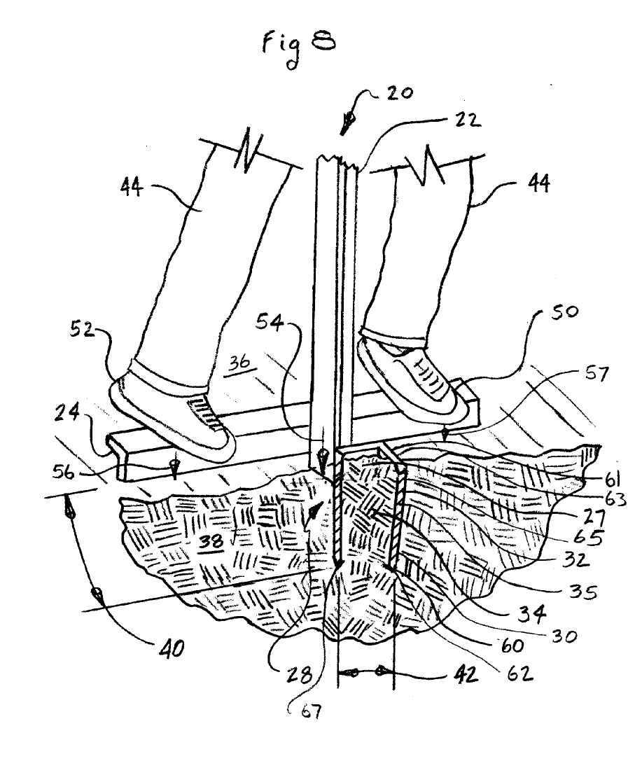

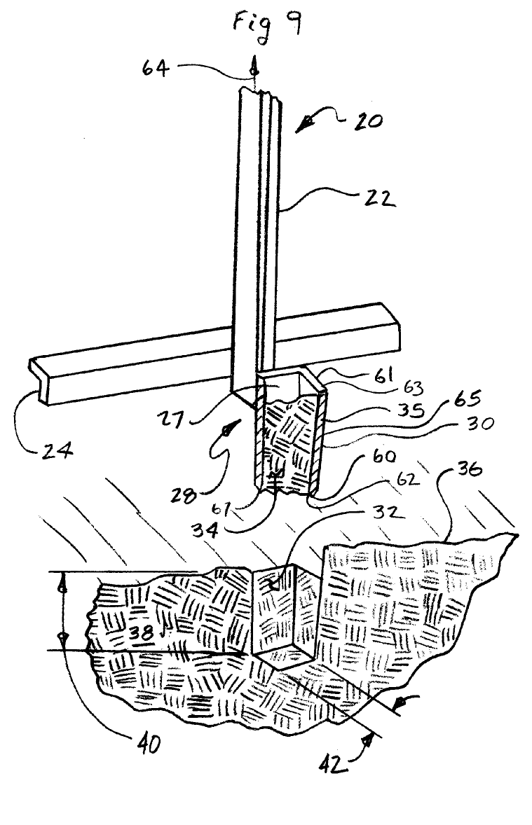

With initial reference to FIG. 1 shown is a perspective view of the hole coring apparatus assembly 20. FIG. 2 shows a perspective view of the open receptacle 28 with a substantially square sidewall 35. FIG. 3 shows a perspective view of the open receptacle 28 with a substantially circular sidewall 37. FIG. 4 shows a perspective view of an open receptacle 28 with a substantially rectangular sidewall 33. FIG. 5 shows a perspective view of an open receptacle 28 with the substantially elliptical sidewall 31. FIG. 6 shows a perspective view of the operator 44 using the hole coring apparatus assembly 20 at the initial penetration of an earth surface 36. FIG. 7 shows a perspective view of the operator 44 using the hole coring apparatus 20 after full penetration of the earth surface 36 utilizing a single operator right foot 52. FIG. 8 shows a perspective view of the operator 44 using the hole coring apparatus 20 after full penetration of the earth surface 36 utilizing both the right foot 52 and the left foot 50. FIG. 9 shows a perspective view of the hole coring apparatus 20 removed from the earth 38 after full penetration of the earth surface 36 with the hole coring apparatus 20 substantially retaining a cored earth plug 34.

Broadly, the present invention of the hole coring apparatus 20 for creating a desired void 32 in the earth surface 36 comprises an open receptacle 28 having longitudinal axis 29, with the open receptacle 28 including a surrounding sidewall 30 positioned substantially symmetrical about the axis 29. The sidewall 30 has a first open end 60 and a second open end 61 that are both substantially transverse to the axis 29 to define a receptacle interior 27, with the first opened end 60 having a perimeter 62 that is less than a second open end 61 perimeter 63. Also included is an extension member 22 that extends from the extension 22 proximal end 21 being positioned adjacent to the exterior 65 of the surrounding sidewall 30 to the extension member 22 distal end 23, with the extension member 22 being substantially parallel to the axis 29. Further included is the driving member 24 adjacent to the extension member 22 being positioned substantially transverse to the axis 29 near the receptacle 28, the driving member 24 is offset in relation to the extension member 22 having a driving member 24 long extension 66 and an opposing driving member 24 short extension 68, wherein the driving member 24 long extension 66 is longer than the driving member 24 short extension 68.

Finally, included in the hole coring apparatus 20 is a handle 26 adjacent to the extension member 22 positioned substantially transverse to the axis 29 located between the driving member 24 and the extension member 22 distal end 23. The handle 26 is approximately co planar with the driving member 24, with the handle 26 being offset in relation to the extension member 22, having a handle 26 long extension 70 and an opposing handle 26 short extension 72, wherein the handle 26 long extension 70 is longer than the handle 26 short extension 72 such that the handle 26 long extension 70 is placed opposite of the driving member 24 long extension 66 in relation to the extension member 22.

More particularly, the surrounding sidewall 30 can assume a number of different shapes depending upon manufacturing and cost requirements, in addition to the desired aspect ratio of the cored earth hole depth 40 relative to the cored hole width 42, also depending upon the desired shape or configuration of the surrounding sidewall 30 being substantially parallel to the first opened end perimeter 62 and the second open end perimeter 63 or in a plane substantially perpendicular to the axis 29. Preferably, the surrounding sidewall 30 is of a substantially square shape 35 in a plane perpendicular to the axis 29 as best shown in FIGS. 1, 2, 6, 7, 8, and 9. Alternatively, the surrounding sidewall 30 could be substantially elliptical 31 in shape in a plane perpendicular to the axis 29 as best shown in FIG. 5. Also, alternatively, the surrounding sidewall could be substantially circular 37 in a plane perpendicular to the axis 29 as best shown in FIG. 3. Further, alternatively the surrounding sidewall could substantially be rectangular 33 in shape in a plane perpendicular to the axis 29 as best shown in FIG. 4. The preferred materials of construction for the surrounding sidewall 30 or steel with a corrosion resistant coating such as galvanizing or powder coating and the like, alternatively the materials of construction for the surrounding sidewall 30 could be stainless steel or a plastic suitable for coring earth 38.

Continuing on the surrounding sidewall 30, the preferred dimensions for the substantially square surrounding sidewall 35 open receptacle and in referring particularly to FIG. 2, are for the height 39 about 5.3 inches, for the second open end width 41 about 2.3 inches, for the first opened end width 43 about 1.7 inches, and for the thickness 45 about 0.060 inches. Further, continuing on the surrounding sidewall 30, the preferred dimensions for the substantially circular surrounding sidewall 37 open receptacle and in referring particularly to FIG. 3, are for the height 80 about 5.3 inches, for the second open end diameter 82 about 2.3 inches, for the first open end diameter 84 about 1.7 inches, and for the thickness 86 about 0.060 inches. Next, on the surrounding sidewall 30 the preferred dimensions for the substantially rectangular surrounding sidewall 33 open receptacle, and in referring particularly to FIG. 4, are for the height 88 about 5.3 inches, for the second open end width 90 about 2.3 inches, for the second open end length 92 about 4.6 inches, for the first open end width 94 about 1.7 inches, for the first open end length 96 about 3.4 inches and for the thickness 97 about 0.060 inches.

Yet, further continuing on the surrounding sidewall 30, the preferred dimensions for the substantially elliptical surrounding sidewall 31 open receptacle, and in referring particularly to FIG. 5, are for the height 98 about 5.3 inches, for the second open end major diameter about 4.6 inches, for the second open end minor diameter 101 about 2.3 inches, for the first opened in major diameter 102 about 3.4 inches, the first open end minor diameter 103 about 1.7 inches, and for the thickness 104 about 0.060 inches. Note, that for the surrounding sidewall 30, other sizes and configurations would be acceptable as desired for the size and configuration of the void 32, as long as a core 34 of earth 38 were removed from the earth's surface 36. As the surrounding sidewall 30 is adjacent to the extension member 22, the preferred attachment of the surrounding sidewall 30 to the extension member 22 is by conventional welding as best shown in FIG. 1, with the surrounding sidewall 30 overlap 59 of about 0.6 inches with the overlap 59 being more or less depending upon the size and configuration of both the surrounding sidewall 30 and the extension member 22. However, other attachment methods with the acceptable such as bolting, screwing, adhesives, threading, slip or shrink fit, and the like as long as the strength of the attachment between the surrounding sidewall 30 and the extension member 22 is adequate for the operator right foot 52 downward force 56 (as best shown in FIGS. 6 and 7) and the operator 44 left hand 46 downward force 58 both to be transmitted from the operator 44 to the extension member 22 and to the surrounding sidewall 30 through a total downward force 54. Also, optionally, on the surrounding sidewall 30 the first open end perimeter 62 were the first open end of the open receptacle 60 can be formed into a leading edge 67 (as best shown in the FIGS. 7, 8, and 9) to ease penetration of the first open end 60 of the open receptacle into the earth 38 surface 36.

Moving in detail to the handle 26 which is preferably constructed of carbon steel round tube stock with a corrosion resistant coating such as galvanizing, or powder coating, and the like, the handle 26 has an outside diameter of about 0.9 inches and an inside diameter of about 0.6 inches, however, other outside and inside diameters and materials of construction would be acceptable as long as the tube outside diameter was sized and configured for the operator's 44 left hand 46 and right hand 48, with the handle 26 having adequate strength for the operator's 44 left hand 46 downward force 58 and the resultant moment 76 as best shown in FIG. 6. Further, on the handle 26 (as best shown in FIG. 1) which is adjacent to the extension member 22 and with the handle 26 positioned substantially transverse to the extension member 22, the handle 26 is also offset in relation to the extension member 22 wherein in the handle 26 long extension 70 being preferably about 10.8 inches and the handle 26 opposing short extension 72 being preferably about 4.9 inches. Note that both the handle 26 long extension 70 and the handle 26 short extension 72 could each be longer or shorter depending upon the operator 44 left hand 46 and operator 44 right hand 48 sizes, operator 44 shoulder width, operator 44 left and right arm length, also the hardness and/or density of the earth 38, and other factors that could affect the desired handle 26 long extension 70 length and the handle 26 short extension 72 length, however, with the need for the handle 26 long extension 70 being longer than the handle 26 short extension 72, as will be explained in the method of use section of the description. As the handle 26 is adjacent to the extension member 22, the preferred attachment of the handle 26 to the extension member 22 is by conventional welding. However, other attachment methods would be acceptable such as bolting, screwing, adhesives, threading, slip or shrink fit, and the like as long as the strength of the attachment between the handle 26 and extension member 22 is adequate for the operator left hand 46 downward force 58 (as best shown in FIG. 6) to be transmitted from the operator 44 to the extension member 22 both as a total downward force 54 and as an operator 44 left hand 46 moment 76 as a total combined load to the attachment between handle 26 and the extension member 22.

Next, moving in detail to the extension member 22 and referring specifically to FIG. 1, the extension member 22 preferred materials of construction are conventional carbon steel angle iron with a corrosion resistant coating such as galvanizing, or powder coating, and the like, the extension member 22 is preferably conventional carbon steel angle iron sized at 1.2 inches by 1.2 inches by 0.12 inches wall thickness with a preferred length 25 of about 30 inches. Alternative materials of construction and the size and configuration of the extension member 22 would be acceptable as long as the strength of the extension member 22 is adequate for the operator left hand 46 downward force 58 (as best shown in FIG. 6) to be transmitted from the operator 44 to the extension member 22, both as a total downward force 54 and as an operator 44 left hand 46 moment 76 as a total combined load to the extension member 22. In addition, the extension member 22 would need to have adequate strength to accommodate the operator right foot 52 downward force 56 (as best shown in FIGS. 6 and 7) to be transmitted from the operator 44 to the extension member 22 by way of the driving member 24, both as a total downward force 54 and as an operator 44 right foot 52 moment 74 as a total combined load to the attachment between the driving member 24 and the extension member 22.

Continuing, on the driving member 24 (as best shown in FIG. 1) which is adjacent to the extension member 22 and with the driving member 24 positioned substantially transverse to the extension 22, the driving member 24 is also offset in relation to extension member 22, wherein there is the driving member 24 long extension 66 which is preferably about 6.5 inches and the opposite driving member 24 short extension 68 which is preferably about 5.3 inches. Note that both the driving member 24 long extension 66 and the driving member 24 short extension 68 could each be longer or shorter depending upon the operator 44 left foot 50 and operator 44 right foot 52 sizes, operator 44 left and right leg length, also hardness and/or density of the earth 38, and other factors that could affect the desired driving member 24 long extension 66 length and the driving member 24 short extension 68 length, however, the need for the driving member long extension 66 being longer than the driving member 24 short extension 68, as will be explained in method of use section of the description. Note that the driving member 24 short extension 68 could be optional, in other words there could be no driving member 24 short extension 68 with the driving member 24 long extension 66 only being present, depending upon whether the operator 44 uses both the left foot 50 and the operator 44 right foot 52 (as best shown in FIG. 8) which would require the driving member 24 long extension 66 and the driving member 24 short extension 68 or the operator 44 uses only the right foot 52 (as best shown in FIGS. 6 and 7) or alternatively only the left foot 50 (not shown) requiring only the driving member 24 long extension 66 without the driving member 24 short extension 68. Note also that at shown in FIG. 1, the driving member 24 option for only the long extension 66 without the driving member 24 short extension 68 could be opposite from what is shown in FIG. 1, with the driving member 24 long extension 66 extending alone opposite from extension member 22 from what is shown in FIG. 1.

As the driving member 24 is adjacent to the extension member 22, the preferred attachment of the driving member 24 to the extension member 22 is by conventional welding. However, other attachment methods would be acceptable such as bolting, screwing, adhesives, slip or shrink fit, and the like as long as the strength of the attachment between the driving member 24 and the extension member 22 is adequate for the operator right foot 52 downward force 56 (as best shown in FIGS. 6 and 7) to be transmitted from the operator 44 to the extension member 22, both as a total downward force 54 and as an operator 44 right foot 52 moment 74 as a total combined load to the attachment between the driving member 24 in the extension member 22. Further, in detail on the driving member 24 and again referring specifically to FIG. 1, the driving member 24 preferred materials of construction are conventional carbon steel angle iron with a corrosion resistant coating such as galvanizing, powder coating, and the like, the driving member 24 is preferably conventional carbon steel angle iron sized at 1.2 inches by 1.2 inches by 0.12 inches wall thickness. Alternative materials of construction and the size and configuration of the driving member 24 would be acceptable as long as the strength of the driving member 24 is adequate for the operator 44 right foot 52 downward force 56 (as best shown in FIGS. 6 and 7) to be transmitted from the operator 44 to the driving member 24, both as a total downward force 56 and as an operator 44 right foot 52 moment 74 as a total combined load to the driving member 24. Optionally, the driving member 24 can be positioned to be substantially co planar with the second open end 61 of the open receptacle (as best shown in FIGS. 7 and 8), wherein the driving member 24 is operational to limit penetration of the open receptacle 28 into the earth 38 surface 36 by the driving member 24 contacting the earth 38 surface 36.

Depending upon the preference of the operator 44 and in referring to FIG. 1, the handle 26 long extension 70 and the handle 26 short extension 72 could be oppositely disposed in relation to the extension member 22 from what is shown and likewise on the driving member 24 the long extension 66 and a short extension 68 could be oppositely disposed from what is shown, or as previously described having only the driving member 24 long extension 66 only without the short extension 68 oppositely disposed from what is shown.

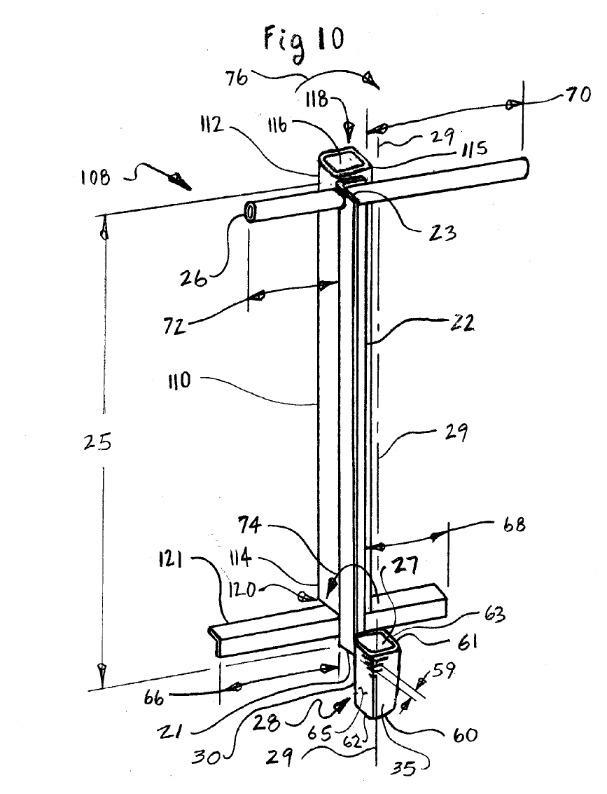

As an alternative embodiment, FIGS. 10 to 18 show the hole coring apparatus assembly 108 with the plant guide member 110 that allows the operator 44 to place the plant 150 into the cored hole 32 by dropping the plant 150 into the plant guide member 110 inlet 118 and through the plant guide member 110 void 116 and out of the plant guide member 110 outlet 120 with the plant 150 ultimately ending up disposed within the cored hole 32. This helps eliminate the need for the operator 44 to bend over to be near the earth 38 surface 36 to manually place the plant 150 into the cored hole 32, thus saving the operator 44 time and reducing operator 44 fatigue.

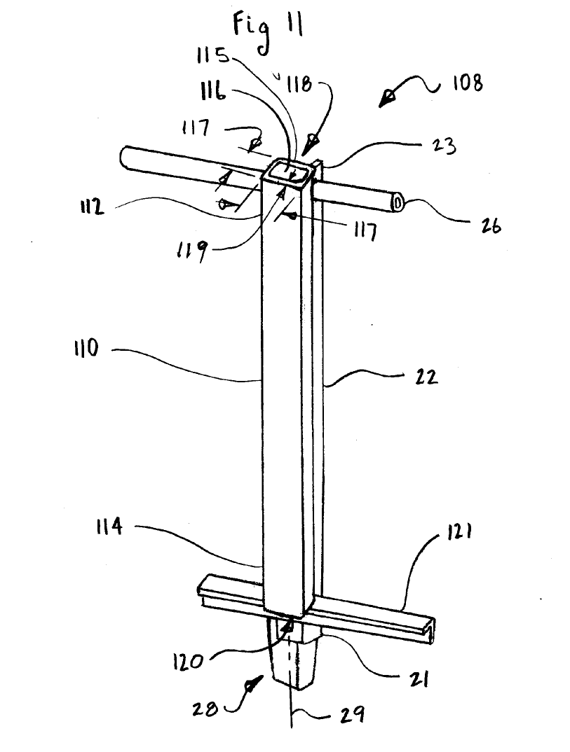

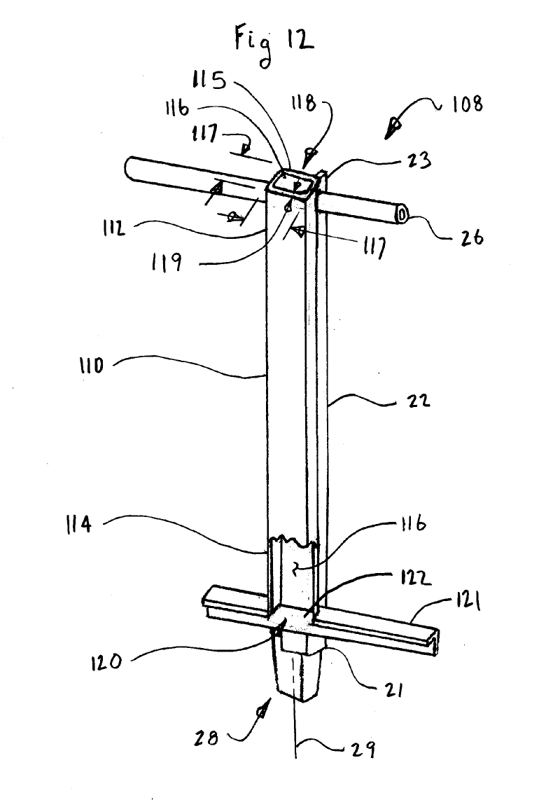

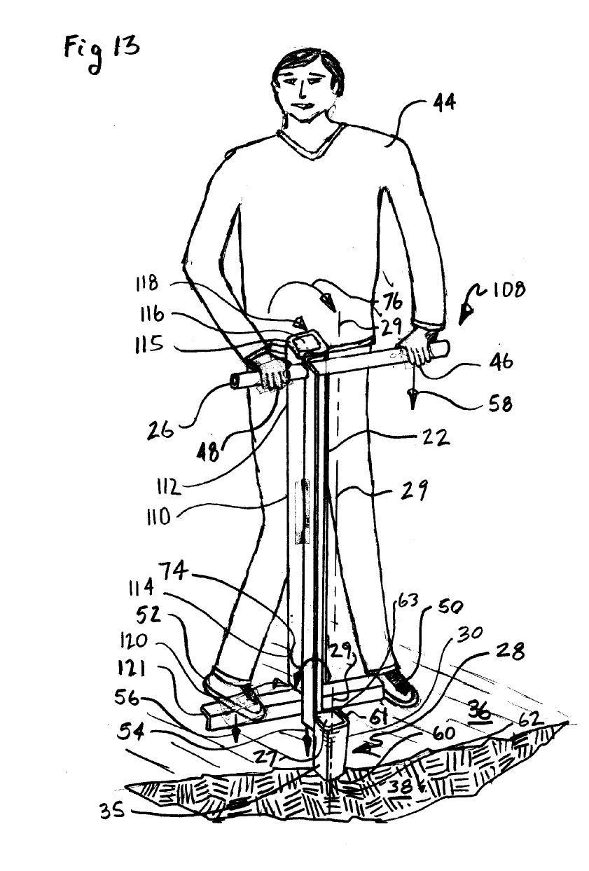

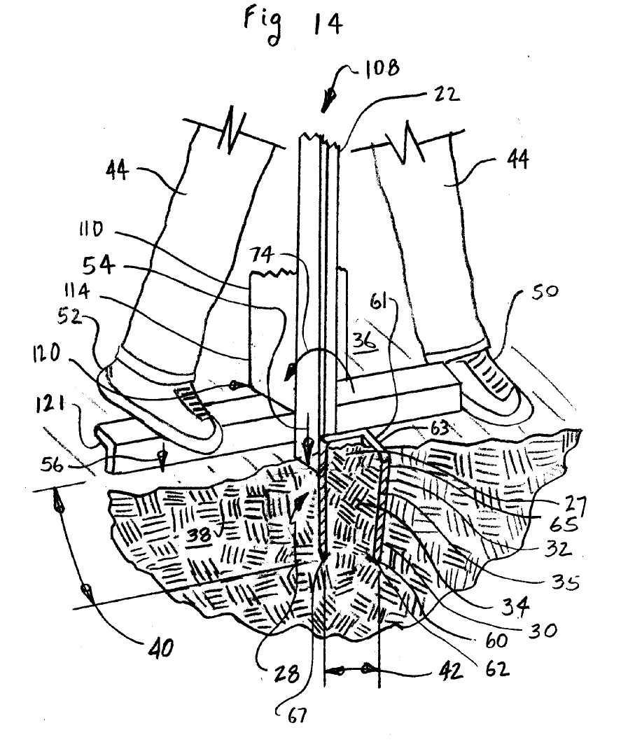

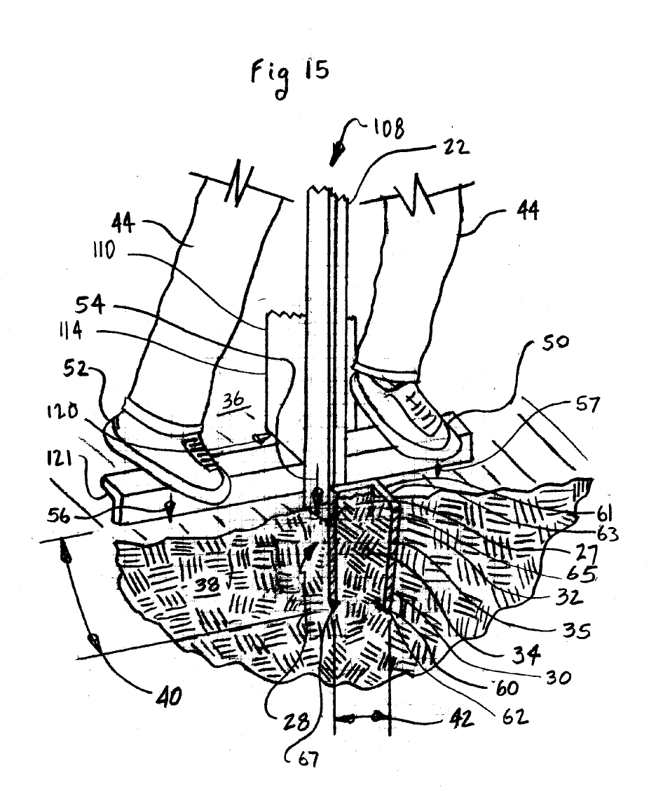

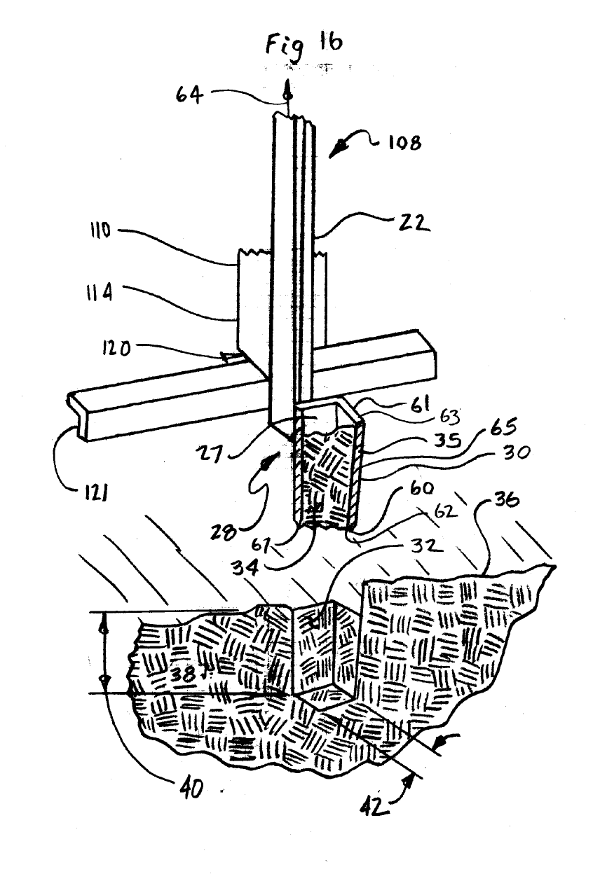

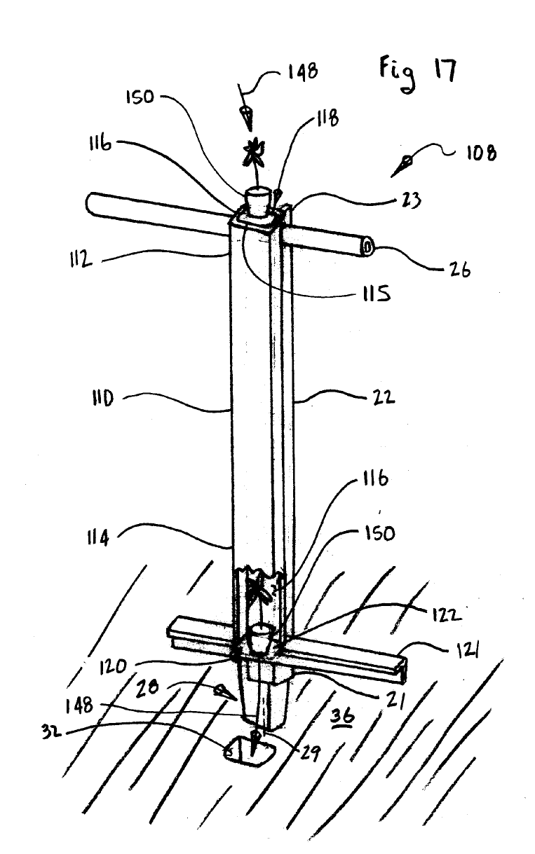

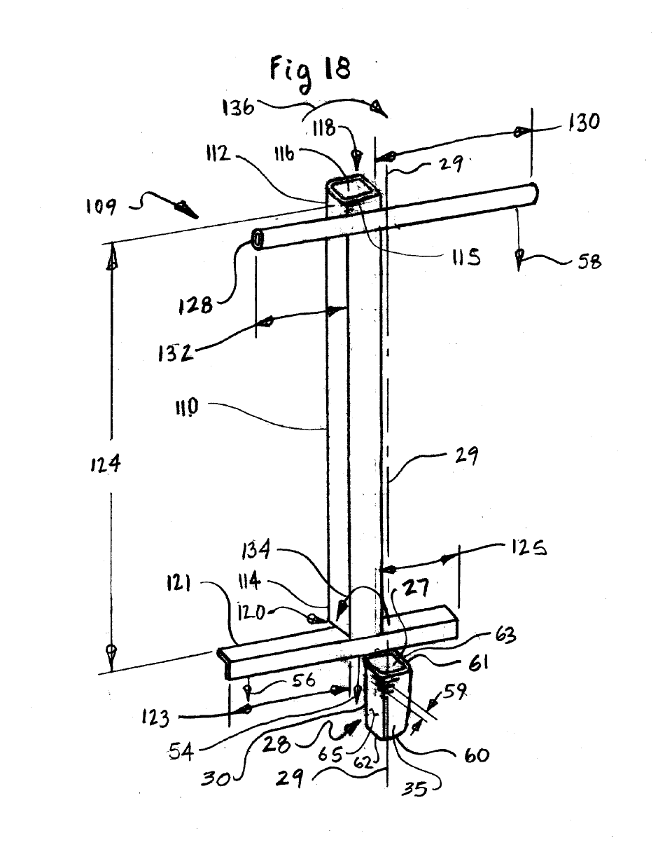

Continuing, FIG. 10 shows a perspective view of the hole coring apparatus assembly 108 with the plant guide member 110 and extension member 22, FIG. 11 shows a reverse rear perspective view in relation to FIG. 10, of the hole coring apparatus assembly 108 with the plant guide member 110, and FIG. 12 shows the same view as FIG. 11, however, with a cutaway view of a second end portion 114 of the plant guide member 110 to show a driving member 121 aperture 122 and the plant guide member outlet 120. Further, FIG. 13 shows a perspective view of the operator 44 using the hole coring apparatus assembly 108 with the plant guide member 110 at initial penetration of the earth 38 surface 36, FIG. 14 shows a perspective view of the operator 44 using the hole coring apparatus assembly 108 with the plant guide member 110 after full penetration of the earth 38 surface 36 utilizing a single operator foot 52, and FIG. 15 shows a perspective view of the operator 44 using the hole coring apparatus assembly 108 with the plant guide member 110 after full penetration of the earth 38 surface 36 utilizing both of the operator's feet 50 and 52. Yet further continuing, FIG. 16 shows a perspective view of the hole coring apparatus assembly 108 with the plant guide member 110, with the hole coring apparatus assembly 108 removed from the earth 38 after full penetration of the earth 38 surface 36 with the hole coring apparatus assembly 108 with the plant guide member 110, substantially retaining a cored earth plug 34, and FIG. 17 shows the same view as FIG. 12, however, being a use drawing showing a plant 150 and a direction of plant 150 movement 148 into, through, and out of the plant guide member 110, with a cutaway of the second end portion 114 of the plant guide member 110 to show the driving member 121 aperture 122 and the plant guide member 110 outlet 120, thus helping to facilitate the ultimate destination of the plant 150 into the cored hole 32, with the operator 44 removed for view clarity. Furthermore, FIG. 18 shows a perspective view of a hole coring apparatus 109 without the extension member 22 assembly with the plant guide member 110 in comparing to FIG. 10 that includes the extension member 22 with the plant guide member 110.

Broadly, in referring to FIGS. 10 to 18 shown are the alternative embodiments of the hole coring apparatus 108 and 109 for creating a desired void 32 in the earth surface 36 to receive a transplanted plant 150 that comprises an open receptacle 28 having longitudinal axis 29, with the open receptacle 28 including a surrounding sidewall 30 positioned substantially symmetrical about the axis 29. The sidewall 30 has a first open end 60 and a second open end 61 that are both substantially transverse to the axis 29 to define a receptacle interior 27, with the first open end 60 having a perimeter 62 that is less than a second open end 61 perimeter 63. Also included is an extension member 22 that extends from the extension member 22 proximal end 21 being positioned adjacent to the exterior 65 of the surrounding sidewall 30 to the extension member 22 distal end 23, with the extension member 22 being substantially parallel to the axis 29. Further included is the driving member 24 adjacent to the extension member 22 being positioned substantially transverse to the axis 29 near the receptacle 28, the driving member 24 is offset in relation to the extension member 22 having a driving member 24 long extension 66 and an opposing driving member 24 short extension 68, wherein the driving member 24 long extension 66 is longer than the driving member 24 short extension 68.

Continuing, included in the hole coring apparatus 108 is a handle 26 adjacent to the extension member 22 positioned substantially transverse to the axis 29 located between the driving member 24 and the extension member 22 distal end 23. The handle 26 is approximately co planar with the driving member 24, with the handle 26 being offset in relation to the extension member 22, having a handle 26 long extension 70 and an opposing handle 26 short extension 72, wherein the handle 26 long extension 70 is longer than the handle 26 short extension 72 such that the handle 26 long extension 70 is placed opposite of the driving member 24 long extension 66 in relation to the extension member 22. Also included, is a plant guide member 110 positioned adjacent to extension member 22 and oriented substantially parallel to the axis 29, wherein the plant guide member 110 is operational to help place the transplanted plant 150 substantially within the void 32 in the earth surface 36 created by the open receptacle 28.

More particularly, in referring to FIGS. 1-18 the surrounding sidewall 30 can assume a number of different shapes depending upon manufacturing and cost requirements, in addition to the desired aspect ratio of the cored earth hole depth 40 relative to the cored hole width 42, also depending upon the desired shape or configuration of the surrounding sidewall 30 being substantially parallel to the first opened end perimeter 62 and the second open end perimeter 63 or in a plane substantially perpendicular to the axis 29. Preferably, the surrounding sidewall 30 is of a substantially square shape 35 in a plane perpendicular to the axis 29 as best shown in FIGS. 10, 11, 12, 13, 14, 15, 16, 17, and 18. Alternatively, the surrounding sidewall 30 could be substantially elliptical 31 in shape in a plane perpendicular to the axis 29 as best shown in FIG. 5. Also, alternatively, the surrounding sidewall could be substantially circular 37 in a plane perpendicular to the axis 29 as best shown in FIG. 3. Further, alternatively the surrounding sidewall could substantially be rectangular 33 in shape in a plane perpendicular to the axis 29 as best shown in FIG. 4. The preferred materials of construction for the surrounding sidewall 30 is steel with a corrosion resistant coating such as galvanizing or powder coating and the like, alternatively the materials of construction for the surrounding sidewall 30 could be stainless steel or a plastic suitable for coring earth 38.

Continuing on the surrounding sidewall 30, the preferred dimensions for the substantially square surrounding sidewall 35 open receptacle and in referring particularly to FIG. 2, are for the height 39 about 5.3 inches, for the second open end width 41 about 2.3 inches, for the first open end width 43 about 1.7 inches, and for the thickness 45 about 0.060 inches. Further, continuing on the surrounding sidewall 30, the preferred dimensions for the substantially circular surrounding sidewall 37 open receptacle and in referring particularly to FIG. 3, are for the height 80 about 5.3 inches, for the second open end diameter 82 about 2.3 inches, for the first open end diameter 84 about 1.7 inches, and for the thickness 86 about 0.060 inches. Next, on the surrounding sidewall 30 the preferred dimensions for the substantially rectangular surrounding sidewall 33 open receptacle, and in referring particularly to FIG. 4, are for the height 88 about 5.3 inches, for the second open end width 90 about 2.3 inches, for the second open end length 92 about 4.6 inches, for the first open end width 94 about 1.7 inches, for the first open end length 96 about 3.4 inches and for the thickness 97 about 0.060 inches.

Yet, further continuing on the surrounding sidewall 30, the preferred dimensions for the substantially elliptical surrounding sidewall 31 open receptacle, and in referring particularly to FIG. 5, are for the height 98 about 5.3 inches, for the second open end major diameter about 4.6 inches, for the second open end minor diameter 101 about 2.3 inches, for the first opened in major diameter 102 about 3.4 inches, the first open end minor diameter 103 about 1.7 inches, and for the thickness 104 about 0.060 inches. Note, that for the surrounding sidewall 30, other sizes and configurations would be acceptable as desired for the size and configuration of the void 32, as long as a core 34 of earth 38 were removed from the earth's surface 36. As the surrounding sidewall 30 is adjacent to the extension member 22, the preferred attachment of the surrounding sidewall 30 to the extension member 22 is by conventional welding as best shown in FIG. 10, with the surrounding sidewall 30 overlap 59 of about 0.6 inches with the overlap 59 being more or less depending upon the size and configuration of both the surrounding sidewall 30 and the extension member 22. However, other attachment methods would be acceptable such as bolting, screwing, adhesives, threading, slip or shrink fit, and the like as long as the strength of the attachment between the surrounding sidewall 30 and the extension member 22 is adequate for the operator right foot 52 downward force 56 (as best shown in FIGS. 6 and 7) and the operator 44 left hand 46 downward force 58 both to be transmitted from the operator 44 to the extension member 22 and to the surrounding sidewall 30 through a total downward force 54. Also, optionally, on the surrounding sidewall 30 the first open end perimeter 62 where the first open end of the open receptacle 60 can be formed into a leading edge 67 (as best shown in the FIGS. 14, 15, and 16) to ease penetration of the first open end 60 of the open receptacle into the earth 38 surface 36.

Moving in detail to the handle 26 which is preferably constructed of carbon steel round tube stock with a corrosion resistant coating such as galvanizing, or powder coating, and the like, the handle 26 has an outside diameter of about 0.9 inches and an inside diameter of about 0.6 inches, however, other outside and inside diameters and materials of construction would be acceptable as long as the tube outside diameter was sized and configured for the operator's 44 left hand 46 and right hand 48, with the handle 26 having adequate strength for the operator's 44 left hand 46 downward force 58 and the resultant moment 76 as best shown in FIG. 13. Further, on the handle 26 (as best shown in FIG. 10) which is adjacent to the extension member 22 and with the handle 26 positioned substantially transverse to the extension member 22, the handle 26 is also offset in relation to the extension member 22 wherein in the handle 26 long extension 70 being preferably about 10.8 inches and the handle 26 opposing short extension 72 being preferably about 4.9 inches. Note that both the handle 26 long extension 70 and the handle 26 short extension 72 could each be longer or shorter depending upon the operator 44 left hand 46 and operator 44 right hand 48 sizes, operator 44 shoulder width, operator 44 left and right arm length, also the hardness and/or density of the earth 38, and other factors that could affect the desired handle 26 long extension 70 length and the handle 26 short extension 72 length, however, with the need for the handle 26 long extension 70 being longer than the handle 26 short extension 72, as will be explained in the method of use section of the description. As the handle 26 is adjacent to the extension member 22, the preferred attachment of the handle 26 to the extension member 22 is by conventional welding. However, other attachment methods would be acceptable such as bolting, screwing, adhesives, threading, slip or shrink fit, and the like as long as the strength of the attachment between the handle 26 and extension member 22 is adequate for the operator left hand 46 downward force 58(as best shown in FIG. 13) to be transmitted from the operator 44 to the extension member 22 both as a total downward force 54 and as an operator 44 left hand 46 moment 76 as a total combined load to the attachment between handle 26 and the extension member 22.

Next, moving in detail to the extension member 22 and referring specifically to FIG. 10, the extension member 22 preferred materials of construction are conventional carbon steel angle iron with a corrosion resistant coating such as galvanizing, or powder coating, and the like, the extension member 22 is preferably conventional carbon steel angle iron sized at 1.2 inches by 1.2 inches by 0.12 inches wall thickness with a preferred length 25 of about 30 inches. Alternative materials of construction and the size and configuration of the extension member 22 would be acceptable as long as the strength of the extension member 22 is adequate for the operator left hand 46 downward force 58 (as best shown in FIG. 13) to be transmitted from the operator 44 to the extension member 22, both as a total downward force 54 and as an operator 44 left hand 46 moment 76 as a total combined load to the extension member 22. In addition, the extension member 22 would need to have adequate strength to accommodate the operator right foot 52 downward force 56 (as best shown in FIGS. 13 and 14) to be transmitted from the operator 44 to the extension member 22 by way of the driving member 24, both as a total downward force 54 and as an operator 44 right foot 52 moment 74 as a total combined load to the attachment between the driving member 24 and the extension member 22.

Continuing, on the driving member 24 (as best shown in FIG. 10) which is adjacent to the extension member 22 and with the driving member 24 positioned substantially transverse to the extension 22, the driving member 24 is also offset in relation to extension member 22, wherein there is the driving member 24 long extension 66 which is preferably about 6.5 inches and the opposite driving member 24 short extension 68 which is preferably about 5.3 inches. Note that both the driving member 24 long extension 66 and the driving member 24 short extension 68 could each be longer or shorter depending upon the operator 44 left foot 50 and operator 44 right foot 52 sizes, operator 44 left and right leg length, also hardness and/or density of the earth 38, and other factors that could affect the desired driving member 24 long extension 66 length and the driving member 24 short extension 68 length, however, the need for the driving member long extension 66 being longer than the driving member 24 short extension 68, as will be explained in method of use section of the description. Note that the driving member 24 short extension 68 could be optional, in other words there could be no driving member 24 short extension 68 with the driving member 24 long extension 66 only being present, depending upon whether the operator 44 uses both the left foot 50 and the operator 44 right foot 52 (as best shown in FIG. 15) which would require the driving member 24 long extension 66 and the driving member 24 short extension 68 or the operator 44 uses only the right foot 52 (as best shown in FIGS. 13 and 14) or alternatively only the left foot 50 (not shown) requiring only the driving member 24 long extension 66 without the driving member 24 short extension 68. Note also that at shown in FIG. 10, the driving member 24 option for only the long extension 66 without the driving member 24 short extension 68 could be opposite from what is shown in FIG. 10, with the driving member 24 long extension 66 extending alone opposite from extension member 22 from what is shown in FIG. 10.

As the driving member 24 is adjacent to the extension member 22, the preferred attachment of the driving member 24 to the extension member 22 is by conventional welding. However, other attachment methods would be acceptable such as bolting, screwing, adhesives, slip or shrink fit, and the like as long as the strength of the attachment between the driving member 24 and the extension member 22 is adequate for the operator right foot 52 downward force 56 (as best shown in FIGS. 13 and 14) to be transmitted from the operator 44 to the extension member 22, both as a total downward force 54 and as an operator 44 right foot 52 moment 74 as a total combined load to the attachment between the driving member 24 in the extension member 22. Further, in detail on the driving member 24 and again referring specifically to FIG. 10, the driving member 24 preferred materials of construction are conventional carbon steel angle iron with a corrosion resistant coating such as galvanizing, powder coating, and the like, the driving member 24 is preferably conventional carbon steel angle iron sized at 1.2 inches by 1.2 inches by 0.12 inches wall thickness. Alternative materials of construction and the size and configuration of the driving member 24 would be acceptable as long as the strength of the driving member 24 is adequate for the operator 44 right foot 52 downward force 56 (as best shown in FIGS. 13 and 14) to be transmitted from the operator 44 to the driving member 24, both as a total downward force 56 and as an operator 44 right foot 52 moment 74 as a total combined load to the driving member 24. Optionally, the driving member 24 can be positioned to be substantially co planar with the second open end 61 of the open receptacle (as best shown in FIGS. 14 and 15), wherein the driving member 24 is operational to limit penetration of the open receptacle 28 into the earth 38 surface 36 by the driving member 24 contacting the earth 38 surface 36.

Depending upon the preference of the operator 44 and in referring to FIG. 10, the handle 26 long extension 70 and the handle 26 short extension 72 could be oppositely disposed in relation to the extension member 22 from what is shown and likewise on the driving member 24 the long extension 66 and a short extension 68 could be oppositely disposed from what is shown, or as previously described having only the driving member 24 long extension 66 only without the short extension 68 oppositely disposed from what is shown.

Referring in particular to FIGS. 10-18, to focus in detail on the plant guide member 110 which is preferably in the form of an open ended chute including a first end portion 112 adjacent to the extension member 22 distal end 23 and a plant guide member 110 second end portion 114 adjacent to the extension member 22 proximal end 21. Preferably, the plant guide member 110 is constructed of a surrounding sidewall 115 that defines a chute interior 116, wherein the chute surrounding sidewall 115 is sized and configured to substantially match the open receptacle 28 surrounding sidewall 30 second open end 61 perimeter 63. Additionally, the chute first end portion 112 terminates in an inlet 118 and the chute second end portion 114 terminates in an outlet 120, wherein the chute inlet 118 and outlet 120 are sized and configured to substantially match the open receptacle 28 surrounding sidewall 30 second open end perimeter 63, wherein the chute inlet 118 is operational to manually receive the transplanted plant 150 with the transplanted plant 150 proceeding through the chute interior 116 by gravity and exiting the chute interior 116 at the outlet 120 by way of movement 148 to ultimately help place the transplanted plant 150 substantially within the void 32 in the earth surface 36 created by the open receptacle 28 to avoid the operator 44 having to bend over close to the earth 38 surface 36 (i.e. otherwise the operator 44 manually having to place the transplanted plant 150 into the hole 32 in the earth 38) to reduce operator 44 muscular strain and fatigue, especially in the case of a high number of transplanted plants 150 to be planted. Preferably, the plant guide member 110 is constructed of square stock carbon steel with a width dimension 117 of about 2.3 inches substantially matching the open receptacle 28 second open end width 41 that is about 2.3 inches, and correspondingly the plant guide member 110 having a sidewall thickness 119 of about 0.060 inches substantially matching the open receptacle 28 sidewall thickness 45. In addition, the preferred length 124 of the plant guide member 110 is about 28.2 inches. However, any other combination of different dimensions for the plant guide member 110 width dimension 117, sidewall thickness 119, and/or length 124 would be acceptable as long as the aforementioned functional characteristics of the plant guide member 110 were maintained. In addition, the materials of construction for the plant guide member 110 are preferably carbon steel with a corrosion resistant coating such as galvanizing, powder coating or the like, alternative materials of construction such as stainless steel or a plastic suitable for contact with earth 38 in an external weather environment would be acceptable that also meet the aforementioned functional requirements for the plant guide member 110.

As another alternative embodiment, focusing particularly on FIG. 18 wherein the hole coring apparatus 109 is shown with the plant guide member 110 and without the extension member 22, wherein the plant guide member 110 performs the functions of the previously described plant guide member 110 functions and the previously described extension member 22 functions. With FIGS. 10 to 17 being referenced to show the remaining common hole coring apparatus assembly 108 elements with the plant guide member 110, however, with the extension member 22 not included as shown in FIG. 18, that allows the operator 44 to place the plant 150 into the cored hole 32 by dropping the plant 150 into the plant guide member 110 inlet 118 and through the plant guide member 110 void 116 and out of the plant guide member 110 outlet 120 with the plant 150 ultimately ending up disposed within the cored hole 32. This helps eliminate the need for the operator 44 to bend over to be near the earth 38 surface 36 to manually place the plant 150 into the cored hole 32, thus saving the operator 44 time and reducing operator 44 fatigue especially in the case of having to plant multiple transplanted plants 150.

Continuing, FIG. 10 shows a perspective view of the hole coring apparatus assembly 108 with the plant guide member 110 and extension member 22, FIG. 11 shows a reverse rear perspective view in relation to FIG. 10, of the hole coring apparatus assembly 108 with the plant guide member 110, and FIG. 12 shows the same view as FIG. 11, however, with a cutaway view of a second end portion 114 of the plant guide member 110 to show a driving member 121 aperture 122 and the plant guide member outlet 120. Further, FIG. 13 shows a perspective view of the operator 44 using the hole coring apparatus assembly 108 with the plant guide member 110 at initial penetration of the earth 38 surface 36, FIG. 14 shows a perspective view of the operator 44 using the hole coring apparatus assembly 108 with the plant guide member 110 after full penetration of the earth 38 surface 36 utilizing a single operator foot 52, and FIG. 15 shows a perspective view of the operator 44 using the hole coring apparatus assembly 108 with the plant guide member 110 after full penetration of the earth 38 surface 36 utilizing both of the operator's feet 50 and 52. Yet further continuing, FIG. 16 shows a perspective view of the hole coring apparatus assembly 108 with the plant guide member 110, with the hole coring apparatus assembly 108 removed from the earth 38 after full penetration of the earth 38 surface 36 with the hole coring apparatus assembly 108 with the plant guide member 110, substantially retaining a cored earth plug 34, and FIG. 17 shows the same view as FIG. 12, however, being a use drawing showing a plant 150 and a direction of plant 150 movement 148 into, through, and out of the plant guide member 110, with a cutaway of the second end portion 114 of the plant guide member 110 to show the driving member 121 aperture 122 and the plant guide member 110 outlet 120, thus helping to facilitate the ultimate destination of the plant 150 into the cored hole 32, with the operator 44 removed for view clarity. Furthermore, FIG. 18 shows a perspective view of the hole coring apparatus 109 without the extension member 22 assembly with the plant guide member 110 in comparing to FIG. 10 that includes the extension member 22 with the plant guide member 110.

Broadly, in referring to FIGS. 10 to 18 shown are the alternative embodiments of the hole coring apparatus 108 (FIGS. 10 to 17) and hole coring apparatus 109 (FIG. 18) for creating a desired void 32 in the earth surface 36 to receive a transplanted plant 150 that comprises an open receptacle 28 having longitudinal axis 29, with the open receptacle 28 including a surrounding sidewall 30 positioned substantially symmetrical about the axis 29. The sidewall 30 has a first open end 60 and a second open end 61 that are both substantially transverse to the axis 29 to define a receptacle interior 27, with the first open end 60 having a perimeter 62 that is less than a second open end 61 perimeter 63. Also included is the plant guide member 110 that extends from the second end portion 114 being positioned adjacent to the exterior 65 of the surrounding sidewall 30 to the a first end portion 112. The plant guide member 110 is in the form of the open ended chute, wherein the chute has a surrounding sidewall 115 that defines a chute interior 116, with the plant guide member 110 being substantially parallel to the axis 29 from the first end portion 112 to the second end portion 114. Further included is the driving member 121 adjacent to the plant guide member 110 being positioned substantially transverse to the axis 29 near the receptacle 28, the driving member 121 is offset in relation to the plant guide member 110 having a driving member 121 long extension 66 (long extension 123 in FIG. 18) and an opposing driving member 121 short extension 68 (short extension 125 in FIG. 18), wherein the driving member 121 long extension 66 (long extension 123 in FIG. 18) is longer than the driving member 121 short extension 68 (short extension 125 in FIG. 18).

Continuing, included in the hole coring apparatus 109 is a handle 128 adjacent to the plant guide member 110 positioned substantially transverse to the axis 29 located between the driving member 121 and the first end portion 112. The handle 128 is approximately co planar with the driving member 121, with the handle 128 being offset in relation to the plant guide member 110, having a handle 128 long extension 130 and an opposing handle 128 short extension 132, wherein the handle 128 long extension 130 is longer than the handle 128 short extension 132 such that the handle 128 long extension 130 is placed opposite of the driving member 121 long extension 123 in relation to the plant guide member 110. Operationally, the plant guide member 110 helps place the transplanted plant 150 substantially within the void 32 in the earth 38 surface 36 created by the open receptacle 28.

More particularly, in referring to FIGS. 1-18 the surrounding sidewall 30 can assume a number of different shapes depending upon manufacturing and cost requirements, in addition to the desired aspect ratio of the cored earth hole depth 40 relative to the cored hole width 42, also depending upon the desired shape or configuration of the surrounding sidewall 30 being substantially parallel to the first open end perimeter 62 and the second open end perimeter 63 or in a plane substantially perpendicular to the axis 29. Preferably, the surrounding sidewall 30 is of a substantially square shape 35 in a plane perpendicular to the axis 29 as best shown in FIGS. 10 to 18. Alternatively, the surrounding sidewall 30 could be substantially elliptical 31 in shape in a plane perpendicular to the axis 29 as best shown in FIG. 5. Also, alternatively, the surrounding sidewall could be substantially circular 37 in a plane perpendicular to the axis 29 as best shown in FIG. 3. Further, alternatively the surrounding sidewall could substantially be rectangular 33 in shape in a plane perpendicular to the axis 29 as best shown in FIG. 4. The preferred materials of construction for the surrounding sidewall 30 is carbon steel with a corrosion resistant coating such as galvanizing or powder coating and the like, alternatively the materials of construction for the surrounding sidewall 30 could be stainless steel or a plastic suitable for coring earth 38.

Continuing on the surrounding sidewall 30, the preferred dimensions for the substantially square surrounding sidewall 35 open receptacle and in referring particularly to FIG. 2, are for the height 39 about 5.3 inches, for the second open end width 41 about 2.3 inches, for the first open end width 43 about 1.7 inches, and for the thickness 45 about 0.060 inches. Further, continuing on the surrounding sidewall 30, the preferred dimensions for the substantially circular surrounding sidewall 37 open receptacle and in referring particularly to FIG. 3, are for the height 80 about 5.3 inches, for the second open end diameter 82 about 2.3 inches, for the first open end diameter 84 about 1.7 inches, and for the thickness 86 about 0.060 inches. Next, on the surrounding sidewall 30 the preferred dimensions for the substantially rectangular surrounding sidewall 33 open receptacle, and in referring particularly to FIG. 4, are for the height 88 about 5.3 inches, for the second open end width 90 about 2.3 inches, for the second open end length 92 about 4.6 inches, for the first open end width 94 about 1.7 inches, for the first open end length 96 about 3.4 inches and for the thickness 97 about 0.060 inches.

Yet, further continuing on the surrounding sidewall 30, the preferred dimensions for the substantially elliptical surrounding sidewall 31 open receptacle, and in referring particularly to FIG. 5, are for the height 98 about 5.3 inches, for the second open end major diameter about 4.6 inches, for the second open end minor diameter 101 about 2.3 inches, for the first opened in major diameter 102 about 3.4 inches, the first open end minor diameter 103 about 1.7 inches, and for the thickness 104 about 0.060 inches. Note, that for the surrounding sidewall 30, other sizes and configurations would be acceptable as desired for the size and configuration of the void 32, as long as a core 34 of earth 38 were removed from the earth's surface 36. As the surrounding sidewall 30 is adjacent to the driving member 121, the preferred attachment of the surrounding sidewall 30 to the driving member 121 is by conventional welding as best shown in FIG. 18. However, other attachment methods would be acceptable such as bolting, screwing, adhesives, threading, slip or shrink fit, and the like as long as the strength of the attachment between the surrounding sidewall 30 and the driving member 121 are adequate for the operator right foot 52 downward force 56 (as best shown in FIGS. 13 and 14) and the operator 44 left hand 46 downward force 58 both to be transmitted from the operator 44 to the plant guide member 110 and to the surrounding sidewall 30 through a total downward force 54 (in combining FIG. 13 for the operator 44 manually created downward force 54 and FIG. 18 for the hole coring apparatus 109 embodiment). Also, optionally, on the surrounding sidewall 30 the first open end perimeter 62 where the first open end of the open receptacle 60 can be formed into a leading edge 67 (as best shown in the FIGS. 14, 15, and 16) to ease penetration of the first open end 60 of the open receptacle into the earth 38 surface 36.

Moving in detail to the handle 128 which is preferably constructed of carbon steel round tube stock with a corrosion resistant coating such as galvanizing, or powder coating, and the like, the handle 128 has an outside diameter of about 0.9 inches and an inside diameter of about 0.6 inches, however, other outside and inside diameters and materials of construction would be acceptable as long as the tube outside diameter was sized and configured for the operator's 44 left hand 46 and right hand 48, with the handle 128 having adequate strength for the operator's 44 left hand 46 downward force 58 and the resultant moment 136 as best shown in FIG. 18. Further, on the handle 128 (as best shown in FIG. 18) which is adjacent to the plant guide member 110 and with the handle 128 positioned substantially transverse to the plant guide member 110, the handle 128 is also offset in relation to the plant guide member 110 wherein in the handle 128 long extension 130 being preferably about 10.8 inches and the handle 128 opposing short extension 132 being preferably about 4.9 inches. Note that both the handle 128 long extension 130 and the handle 128 short extension 132 could each be longer or shorter depending upon the operator 44 left hand 46 and operator 44 right hand 48 sizes, operator 44 shoulder width, operator 44 left and right arm length, also the hardness and/or density of the earth 38, and other factors that could affect the desired handle 128 long extension 130 length and the handle 128 short extension 132 length, however, with the need for the handle 128 long extension 130 being longer than the handle 128 short extension 132, as will be explained in the method of use section of the description. As the handle 128 is adjacent to the plant guide member 110, the preferred attachment of the handle 128 to the plant guide member 110 is by conventional welding. However, other attachment methods would be acceptable such as bolting, screwing, adhesives, threading, slip or shrink fit, and the like as long as the strength of the attachment between the handle 128 and plant guide member 110 is adequate for the operator left hand 46 downward force 58 (as best shown in FIG. 13) to be transmitted from the operator 44 to the plant guide member 110 both as a total downward force 54 and as an operator 44 left hand 46 moment 136 (shown in FIG. 18) as a total combined load to the attachment between handle 128 and the plant guide member 110.

Continuing, on the driving member 121 (as best shown in FIGS. 17 and 18) which is adjacent to the plant guide member 110 and with the driving member 121 positioned substantially transverse to the plant guide member 110, the driving member 121 is also offset in relation to plant guide member 110, wherein there is the driving member 121 long extension 123 which is preferably about 6.5 inches and the opposite driving member 121 short extension 125 which is preferably about 5.3 inches. Note that both the driving member 121 long extension 123 and the driving member 121 short extension 125 could each be longer or shorter depending upon the operator 44 left foot 50 and operator 44 right foot 52 sizes, operator 44 left and right leg length, also hardness and/or density of the earth 38, and other factors that could affect the desired driving member 121 long extension 123 length and the driving member 121 short extension 125 length, however, the need for the driving member long extension 123 being longer than the driving member 121 short extension 125, as will be explained in method of use section of the description. Note that the driving member 121 short extension 125 could be optional, in other words there could be no driving member 121 short extension 125 with the driving member 121 long extension 123 only being present, depending upon whether the operator 44 uses both the left foot 50 and the operator 44 right foot 52 (as best shown in FIG. 15) which would require the driving member 121 long extension 123 and the driving member 121 short extension 125 or the operator 44 uses only the right foot 52 (as best shown in FIGS. 13 and 14) or alternatively only the left foot 50 (not shown) requiring only the driving member 121 long extension 123 without the driving member 121 short extension 125. Note also that as shown in FIG. 18, the driving member 121 option for only the long extension 123 without the driving member 121 short extension 125 could be opposite from what is shown in FIG. 18, with the driving member 121 long extension 123 extending alone opposite from plant guide member 110 from what is shown in FIG. 18. The driving member 121 also can have the aperture 122 (as best shown in FIG. 17) which allows for the plant guide member 110 interior 116 to have a clear communication passage from the inlet 118 to the outlet 120 and on to the earth void 32 for the transplanted plant 150 traveling in movement 148, however, (in referring to both FIGS. 17 and 18) the aperture 122 is not required if the plant guide member 110 is positioned adjacent to the driving member 121 opposite of the open receptacle 28 position in relation to the driving member 121 as shown in FIG. 18, resulting in the driving member 121 not blocking the communication passage through the plant guide member 110 which allows for the plant guide member 110 interior 116 to have a clear communication passage from the inlet 118 to the outlet 120 and on to the earth void 32 for the transplanted plant 150 traveling in movement 148, thus not requiring the aperture 122 in the driving member 121.

As the driving member 121 is adjacent to the plant guide member 110, the preferred attachment of the driving member 121 to the plant guide member 110 is by conventional welding. However, other attachment methods would be acceptable such as bolting, screwing, adhesives, slip or shrink fit, and the like as long as the strength of the attachment between the driving member 121 and the plant guide member 110 is adequate for the operator right foot 52 downward force 56 (as best shown in FIGS. 13, 14, and 18) to be transmitted from the operator 44 to the plant guide member 110, both as a total downward force 54 and as an operator 44 right foot 52 moment 134 as a total combined load to the attachment between the driving member 121 and the plant guide member 110. Further, in detail on the driving member 121 and again referring specifically to FIGS. 17 and 18, the driving member 121 preferred materials of construction are conventional carbon steel angle iron with a corrosion resistant coating such as galvanizing, powder coating, and the like, the driving member 121 is preferably conventional carbon steel angle iron sized at 1.2 inches by 1.2 inches by 0.12 inches wall thickness. Alternative materials of construction and the size and configuration of the driving member 121 would be acceptable as long as the strength of the driving member 121 is adequate for the operator 44 right foot 52 downward force 56 (as best shown in FIGS. 13, 14, and 18) to be transmitted from the operator 44 to the driving member 121, both as a total downward force 56 and as an operator 44 right foot 52 moment 134 as a total combined load to the driving member 121. Optionally, the driving member 121 can be positioned to be substantially co planar with the second open end 61 of the open receptacle (as best shown in FIG. 18), wherein the driving member 121 is operational to limit penetration of the open receptacle 28 into the earth 38 surface 36 by the driving member 121 contacting the earth 38 surface 36 (as best shown in FIGS. 14 and 15, only for the driving member 121 contacting the earth 38 surface 36).

Depending upon the preference of the operator 44 and in referring to FIG. 18, the handle 128 long extension 130 and the handle 128 short extension 132 could be oppositely disposed in relation to the plant guide member 110 from what is shown and likewise on the driving member 121 the long extension 123 and a short extension 125 could be oppositely disposed from what is shown, or as previously described having only the driving member 121 long extension 123 only without the short extension 125 oppositely disposed from what is shown.

Referring in particular to FIGS. 10-18, to focus in detail on the plant guide member 110 which is preferably in the form of an open ended chute including a first end portion 112 and a plant guide member 110 second end portion 114. Preferably, the plant guide member 110 is constructed of a surrounding sidewall 115 that defines a chute interior 116, wherein the chute surrounding sidewall 115 is sized and configured to substantially match the open receptacle 28 surrounding sidewall 30 second open end 61 perimeter 63. Additionally, the chute first end portion 112 terminates in an inlet 118 and the chute second end portion 114 terminates in an outlet 120, wherein the chute inlet 118 and outlet 120 are sized and configured to substantially match the open receptacle 28 surrounding sidewall 30 second open end perimeter 63, wherein the chute inlet 118 is operational to manually receive the transplanted plant 150 with the transplanted plant 150 proceeding through the chute interior 116 by gravity and exiting the chute interior 116 at the outlet 120 by way of movement 148 to ultimately help place the transplanted plant 150 substantially within the void 32 in the earth surface 36 created by the open receptacle 28 to avoid the operator 44 having to bend over close to the earth 38 surface 36 (i.e. otherwise the operator 44 manually having to place the transplanted plant 150 into the hole 32 in the earth 38) to reduce operator 44 muscular strain and fatigue, especially in the case of a high number of transplanted plants 150 to be planted. Preferably, the plant guide member 110 is constructed of square stock carbon steel with a width dimension 117 of about 2.3 inches substantially matching the open receptacle 28 second open end width 41 that is about 2.3 inches, and correspondingly the plant guide member 110 having a sidewall thickness 119 of about 0.060 inches substantially matching the open receptacle 28 sidewall thickness 45. In addition, the preferred length 124 of the plant guide member 110 is about 28.2 inches. However, any other combination of different dimensions for the plant guide member 110 width dimension 117, sidewall thickness 119, and/or length 124 would be acceptable as long as the aforementioned functional characteristics of the plant guide member 110 were maintained. Alternative materials of construction and the size and configuration of the plant guide member 110 would be acceptable as long as the strength of the plant guide member 110 is adequate for the operator left hand 46 downward force 58 (as best shown in FIG. 13 for the force 58 for the embodiment of the hole coring apparatus 109 in FIG. 18) to be transmitted from the operator 44 to the plant guide member 110, both as a total downward force 54 and as an operator 44 left hand 46 moment 136 as a total combined load to the plant guide member 110. In addition, the plant guide member 110 would need to have adequate strength to accommodate the operator right foot 52 downward force 56 (as best shown in FIGS. 13 and 14 with the hole coring apparatus 109 embodiment in FIG. 18) to be transmitted from the operator 44 to the plant guide member 110 by way of the driving member 121, both as a total downward force 54 and as an operator 44 right foot 52 moment 134 as a total combined load to the attachment between the driving member 121 and the plant guide member 110. In addition, the materials of construction for the plant guide member 110 are preferably carbon steel with a corrosion resistant coating such as galvanizing, powder coating or the like, alternative materials of construction such as stainless steel or a plastic suitable for contact with earth 38 in an external weather environment would be acceptable that also meet the aforementioned functional requirements for the plant guide member 110 that functions without the extension member 22.

Method of Use

A method is disclosed for creating a desired void 32 in an earth 38 surface 36 with the operator 44 manually using the hole coring apparatus assembly 20, comprising the following steps of first providing a hole coring apparatus assembly 20 that includes an open receptacle 28 with a longitudinal axis 29, an extension member 22 extending from the extension member 22 proximal end 21 being adjacent to the open receptacle 28 to the extension member 22 distal end 23. Also included in the hole coring apparatus assembly 20, the extension member 22 is substantially parallel to the axis 29, with the driving member 24 being adjacent to the extension member 22, and the driving member 24 being positioned substantially transverse to the axis 29 near the open receptacle 28. The driving member 24 is offset in relation to the extension member 22, wherein the driving member 24 includes a driving member 24 long extension 66 and an opposing driving member 24 short extension 68, additionally, there is the handle 26 that is adjacent to the extension member 22, with the handle 26 being positioned substantially transverse to the axis 29, with the handle 26 being located between the driving member 24 and the extension member 22 distal end 23. The handle 26 is approximately co planar with the driving member 24 (as best shown in FIG. 1), with the handle 26 being offset in relation to the extension member 22, with the handle 26 including a handle 26 long extension 70 and an opposing handle 26 short extension 72, such that the handle 26 long extension 70 is placed opposite of the driving member 24 long extension 66 in relation to the extension member 22 (also as best shown in FIG. 1).

A next step is in positioning the open receptacle 28 of the hole coring apparatus assembly 20 to a selected location on the earth 38 surface 36 wherein the desired void 32 is to be located on the earth 38 surface 36. Continuing, a further step is placing the right foot 52 of the operator 44, upon the driving member 24 long extension 66 by bending the right knee of the operator 44, while leaving the left foot 50 of the operator 44 to remain on the earth 38 surface 36 by having the operator's left leg extended, wherein the operator's 44 stability is enhanced on the earth 38 surface 36 (as best shown in FIG. 6). Yet further, a next step is placing the left-hand 46 of the operator 44 upon the handle 26 long extension 70 with the left arm of the operator 44 extended (as best shown by combining FIGS. 1 and 6). Next, the operator 44 engages in placing the right hand 48 upon the handle 26 short handle extension 72 by bending the operator's 44 right arm elbow (again as best shown by combining FIGS. 1 and 6). At this point the next step for the operator 44 is to engage in applying a total downward force 54 by the operator 44, with the total downward force 54 being created by the operator 44 by simultaneously applying force 56 on the right foot 52 of the operator 44 upon the driving member 24 long extension 66 and a downward force 58 on the left-hand 46 of the operator 44 upon the handle 26 long extension 70, wherein the open receptacle 28 penetrates the earth 38 surface 36 with the axis 29 being substantially perpendicular to the earth 38 surface (as best shown in FIGS. 1 and 6).

Note that in referring in particular to FIG. 6, that the moment 76 created by the operator's 44 left hand force 58 on the handle 26 long extension 70 that translates into the extension member 22 and the moment 74 created by the operator's 44 right foot 52 force 56 on the driving member 24 long extension 66 into the extension member 22 act to substantially cancel each other out resulting in a total downward force 54 on the extension member 22 that further translates into the open receptacle 28 to penetrate the earth 38 surface 36. The helpful benefit of the substantially canceling moments 76 and 74 is to allow for a higher downward force 54 while at the same time helping the operator 44 retain some degree of stability on the earth 38 surface 36 while driving or penetrating the open receptacle 28 into the earth 38 surface 36, this is as opposed to the operator 44 using for instance a conventional shovel wherein there is no offset to the moment created by the operator 44 applying force with one foot to one side of the shovel resulting in a lower penetrating force for the shovel to pierce the earth or 38 surface 36, especially in hard compact dry earth 38. If, while using a conventional shovel the operator 44 attempts to use both the right foot 52 and the left foot 50 on the shovel, with one foot on each side of the shovel handle to increase the downward force on the shovel to more easily penetrate the earth 38 surface 36, the stability of the operator 44 is greatly decreased as the operator 44 has no contact with the earth 38 surface 36 resulting in a higher potential risk for injury from falling.

Further, the next step is in continuing the downward force 54 on the right foot 52 and the downward force 58 with the left hand 46 until the open receptacle 28 penetrates the earth 38 surface 36 to a selected core hole depth 40 (as best shown in FIG. 7). A final step of removing the hole coring apparatus assembly 20 from the earth 38 surface 36 is by applying an upward force on the handle 26 from the left 46 and right 48 hands of the operator 44 resulting in total upward force 64, wherein upward force 64 should be of a lower magnitude than the total downward force 54 due to the open receptacle 28 having the first open end 60 with a perimeter 62 that is less than the second open in 61 perimeter 63 resulting in the surrounding sidewall 30 having a slight taper inward from the second open end 61 to the first open end 60. Thus, as the open receptacle 28 is withdrawn from the earth 38 (as best shown in FIG. 9) there is substantially no frictional contact between the surrounding sidewall 30 exterior 65 and the earth 38, subsequently resulting in the desired void 32 being created in the earth 38 surface 36 in such that a cored earth plug 34 is substantially retained by the open receptacle 28. The final result is in the void 32 receiving a root ball from a tree or a plant for planting in the earth 38.

Referring in particular to FIG. 7, optionally the aforementioned step of continuing the downward force 54 is continued until the driving member 24 contacts the earth 38 surface 36, basically using the driving member 24 to earth 38 surface 36 contact as a gage to set the cored hole depth 40, resulting in the cored hole depth 40 being consistent from void 32 to void 32 when using the hole coring apparatus assembly 20 for a plurality of voids 32 to be created on the earth 38 surface 36 in a row or other pattern. Note that when the hole coring apparatus 20 is used for a plurality of voids 32, the core 34 from the previous void 32 will be driven out by the subsequent core 34 that forms the subsequent void 32 and continuing onward. Also, as an option and in referring particularly to FIG. 8, the aforementioned step of continuing the downward force 54 is continued using both the operator's 44 right foot 52 and left foot 50 on the driving member 24 long extension 66 and short extension 68 respectively, being operational to further increase the downward force 54 to accommodate especially hard compact dry earth 38. In order to overcome the aforementioned operator 44 stability problem by not having at least either the operator's 44 right foot 52 when the left foot 50 on the earth 38 surface 36 during the step of continuing the downward force 54, the placing of the operator's 44 right foot 52 and left foot 50 on the driving member 24 as described above should not be done until the open receptacle 28 is at least partially penetrated into the earth 38 surface 36 to allow the open receptacle 28 to have some measure of lateral or axis 29 stability in relation to the earth's surface 36 for the operator 44 to remove both the right foot 52 and/or left foot 50 the earth 38 surface 36 and onto the driving member 24 as previously described.

The above described method of use, referring particularly to FIG. 6, can also be applied in an opposite handed and footed sense in that instead of placing the operator 44 right foot 52 on the driving member 24 long extension 66 and keeping the operator 44 left foot 50 on the earth 38 surface 36, the operator 44 could place their left foot 50 on the driving member 24 long extension 66 and keeping the operator 44 right foot 52 on the earth 38 surface 36, this could be accomplished either by the operator 44 facing the opposite side of the hole coring apparatus 20 than as shown in FIG. 6, or by having the driving member 24 long extension 66 and short extension 68 reversed in relation to the extension member 22. In a like manner, instead of the operator 44 placing their left hand 46 on the handle 26 long extension 70 and their right hand 48 on the handle 26 short extension 72, the operator 44 could place their right hand 48 on handle 26 long extension 70 and their left hand 46 on the handle 26 short extension 72 again either by the operator 44 facing the opposite side of the hole coring apparatus 20 than as shown in FIG. 6, or by having the handle 26 long extension 70 and short extension 72 reversed in relation to the extension member 22. The operator 44 would then use the hole coring apparatus 20 as previously described reversing the left hand 46 and right hand 48 use and the operator 44 left foot 50 and right foot 52 use.

A method is disclosed for creating a desired void 32 in an earth 38 surface 36 to receive a transplanted plant 150, with the operator 44 manually using the hole coring apparatus assembly 108 or 109, comprising the following steps of first providing a hole coring apparatus assembly 108 or 109 that includes an open receptacle 28 with a longitudinal axis 29, a plant guide member 110 extending from a second end portion 114 being adjacent to being adjacent to the open receptacle 28 to a first end portion 112, the plant guide member 110 is substantially parallel to the axis 29, with the driving member 121 being adjacent to the plant guide member 110, and the driving member 121 being positioned substantially transverse to the axis 29 near the open receptacle 28. The driving member 121 is offset in relation to the plant guide member 110, wherein the driving member 121 includes a driving member 121 long extension 66 or 123 and an opposing driving member 121 short extension 68 or 125, additionally, there is the handle 26 or 128 that is adjacent to the plant guide member 110, with the handle 26 or 128 being positioned substantially transverse to the axis 29, with the handle 26 or 128 being located between the driving member 121 and the first end portion 112. The handle 26 or 128 is approximately co planar with the driving member 121 (as best shown in FIGS. 17 and 18), with the handle 26 or 128 being offset in relation to the plant guide member 110, with the handle 26 or 128 including a handle 26 or 128 long extension 70 or 130 respectively and an opposing handle 26 or 128 short extension 72 or 132 respectively, such that the handle 26 or 128 long extension 70 or 130 is placed opposite of the driving member 121 long extension 66 or 123 respectively in relation to the plant guide member 110 (also as best shown in FIGS. 10 and 18).

A next step is in positioning the open receptacle 28 of the hole coring apparatus assembly 108 or 109 to a selected location on the earth 38 surface 36 wherein the desired void 32 is to be located on the earth 38 surface 36. Continuing, a further step is placing the right foot 52 of the operator 44, upon the driving member 121 long extension 66 or 123 by bending the right knee of the operator 44, while leaving the left foot 50 of the operator 44 to remain on the earth 38 surface 36 by having the operator's left leg extended, wherein the operator's 44 stability is enhanced on the earth 38 surface 36 (as best shown in FIG. 13). Yet further, a next step is placing the left-hand 46 of the operator 44 upon the handle 26 or 128 long extension 70 or 130 with the left arm of the operator 44 extended (as best shown by combining FIGS. 10 and 13). Next, the operator 44 engages in placing the right hand 48 upon the handle 26 or 128 short handle extension 72 or 132 by bending the operator's 44 right arm elbow (again as best shown by combining FIGS. 11 and 13). At this point the next step for the operator 44 is to engage in applying a total downward force 54 by the operator 44, with the total downward force 54 being created by the operator 44 by simultaneously applying force 56 on the right foot 52 of the operator 44 upon the driving member 121 long extension 66 or 123 and a downward force 58 on the left-hand 46 of the operator 44 upon the handle 26 or 128 long extension 70 or 130, wherein the open receptacle 28 penetrates the earth 38 surface 36 with the axis 29 being substantially perpendicular to the earth 38 surface (as best shown in FIGS. 10 and 13).

Note that in referring in particular to FIGS. 13 and 18, that the moment 76 or 136 respectively created by the operator's 44 left hand force 58 on the handle 26 or 128 long extension 70 or 130 that translates into the plant guide member 110 and the moment 74 or 134 (see FIGS. 13 and 18 respectively) created by the operator's 44 right foot 52 force 56 on the driving member 121 long extension 66 or 123 into the plant guide member 110 act to substantially cancel each other out resulting in a total downward force 54 on the plant guide member 110 that further translates into the open receptacle 28 to penetrate the earth 38 surface 36. The helpful benefit of the substantially canceling moments 76 or 136 and 74 or 134 is to allow for a higher downward force 54 while at the same time helping the operator 44 retain some degree of stability on the earth 38 surface 36 while driving or penetrating the open receptacle 28 into the earth 38 surface 36, this is as opposed to the operator 44 using for instance a conventional shovel wherein there is no offset to the moment created by the operator 44 applying force with one foot to one side of the shovel resulting in a lower penetrating force for the shovel to pierce the earth or 38 surface 36, especially in hard compact dry earth 38. If, while using a conventional shovel the operator 44 attempts to use both the right foot 52 and the left foot 50 on the shovel, with one foot on each side of the shovel handle to increase the downward force on the shovel to more easily penetrate the earth 38 surface 36, the stability of the operator 44 is greatly decreased as the operator 44 has no contact with the earth 38 surface 36 resulting in a higher potential risk for injury from falling.

Further, the next step is in continuing the downward force 54 on the right foot 52 and the downward force 58 with the left hand 46 until the open receptacle 28 penetrates the earth 38 surface 36 to a selected core hole depth 40 (as best shown in FIG. 14). A still further step is of removing the hole coring apparatus assembly 108 or 109 from the earth 38 surface 36 is by applying an upward force on the handle 26 from the left 46 and right 48 hands of the operator 44 resulting in total upward force 64, wherein upward force 64 should be of a lower magnitude than the total downward force 54 due to the open receptacle 28 having the first open end 60 with a perimeter 62 that is less than the second open in 61 perimeter 63 resulting in the surrounding sidewall 30 having a slight taper inward from the second open end 61 to the first open end 60. Thus, as the open receptacle 28 is withdrawn from the earth 38 (as best shown in FIG. 16) there is substantially no frictional contact between the surrounding sidewall 30 exterior 65 and the earth 38, subsequently resulting in the desired void 32 being created in the earth 38 surface 36 in such that a cored earth plug 34 is substantially retained by the open receptacle 28. A yet further step is in positioning the plant guide member 110, and particularly the plant guide member 110 outlet 120 to be substantially above the void 32 in the earth's surface 36 as best shown in FIG. 17 for either the hole coring apparatus assembly 108 or 109 so that movement 148 of the transplanted plant 150 results in the transplanted plant 150 being received substantially into the void 32. Continuing, a step of dropping the transplanted plant 150 into the plant guide member 110 inlet 118 to release the transplanted plant 150 into the plant guide member 110 interior 116 facilitating movement 148 of the transplanted plant 150 through the plant guide member 110 interior 116 wherein the transplanted plant 150 proceeds out of the plant guide member 110 outlet 120 with the transplanted plant 150 being received substantially into the void 32 in the earth surface 36 created by the open receptacle 28 again as best shown in FIG. 17. This helps eliminate the need for the operator 44 to bend over to be near the earth 38 surface 36 to manually place the plant 150 into the cored hole 32, thus saving the operator 44 time and reducing operator 44 fatigue especially in the case of having to plant multiple transplanted plants 150.

Referring in particular to FIG. 14, optionally the aforementioned step of continuing the downward force 54 is continued until the driving member 121 contacts the earth 38 surface 36, basically using the driving member 121 to earth 38 surface 36 contact as a gage to set the cored hole depth 40, resulting in the cored hole depth 40 being consistent from void 32 to void 32 when using the hole coring apparatus assembly 108 or 109 for a plurality of voids 32 to be created on the earth 38 surface 36 in a row or other pattern. Note that when the hole coring apparatus 108 or 109 is used for a plurality of voids 32, the core 34 from the previous void 32 will be driven out by the subsequent core 34 that forms the subsequent void 32 and continuing onward. Also, as an option and in referring particularly to FIG. 15, and in referencing FIGS. 10 and 18 the aforementioned step of continuing the downward force 54 is continued using both the operator's 44 right foot 52 and left foot 50 on the driving member 121 long extension 66 or 123 and short extension 68 or 125 respectively, being operational to further increase the downward force 54 to accommodate especially hard compact dry earth 38. In order to overcome the aforementioned operator 44 stability problem by not having at least either the operator's 44 right foot 52 when the left foot 50 on the earth 38 surface 36 during the step of continuing the downward force 54, the placing of the operator's 44 right foot 52 and left foot 50 on the driving member 121 as described above should not be done until the open receptacle 28 is at least partially penetrated into the earth 38 surface 36 to allow the open receptacle 28 to have some measure of lateral or axis 29 stability in relation to the earth's surface 36 for the operator 44 to remove both the right foot 52 and/or left foot 50 the earth 38 surface 36 and onto the driving member 24 as previously described.

The above described method of use, referring particularly to FIG. 13, and referencing FIGS. 10 and 18 can also be applied in an opposite handed and footed sense in that instead of placing the operator 44 right foot 52 on the driving member 121 long extension 66 or 123 and keeping the operator 44 left foot 50 on the earth 38 surface 36, the operator 44 could place their left foot 50 on the driving member 121 long extension 66 or 123 and keeping the operator 44 right foot 52 on the earth 38 surface 36, this could be accomplished either by the operator 44 facing the opposite side of the hole coring apparatus 108 or 109 than as shown in FIG. 13, or by having the driving member 121 long extension 66 or 123 and short extension 68 or 125 reversed in relation to the plant guide member 110. In a like manner, instead of the operator 44 placing their left hand 46 on the handle 26 or 128 long extension 70 or 130 respectively and their right hand 48 on the handle 26 or 128 short extension 72 or 132 respectively, the operator 44 could place their right hand 48 on handle 26 or 128 long extension 70 or 130 and their left hand 46 on the handle 26 or 128 short extension 72 or 132 again either by the operator 44 facing the opposite side of the hole coring apparatus 108 or 109 than as shown in FIG. 13, or by having the handle 26 or 128 long extension 70 or 130 and short extension 72 or 132 reversed in relation to the plant guide member 110. The operator 44 would then use the hole coring apparatus 108 or 109 as previously described reversing the left hand 46 and right hand 48 use and the operator 44 left foot 50 and right foot 52 use.

### CONCLUSION

Accordingly, the present invention of a hole coring apparatus assembly 20 or the alternative embodiments 108 or 109 have been described with some degree of particularity directed to the embodiments of the present invention. It should be appreciated, though, that the present invention is defined by the following claims construed in light of the prior art so modifications of the changes may be made to the exemplary embodiments of the present invention without departing from the inventive concepts contained therein.

What is claimed is:

1. A hole coring apparatus for creating a desired void in an earth surface to receive a transplanted plant, comprising:
(a) an open receptacle having a longitudinal axis, said open receptacle includes a surrounding sidewall positioned substantially symmetrical about said axis, said sidewall having a first open end and a second open end that are both substantially transverse to said axis to define a receptacle interior, said first open end having a perimeter that is less that a second open end perimeter;
(b) an extension member extending from a proximal end being adjacent to an exterior of said open receptacle sidewall to a distal end, said extension member is substantially parallel to said axis;
(c) a driving member adjacent to said extension member positioned substantially transverse to said axis near said receptacle, said driving member is offset in relation to said extension member having a driving member long extension and an opposing driving member short extension, wherein said driving member long extension is longer than said driving member short extension;
(d) a handle adjacent to said extension member positioned substantially transverse to said axis located between said driving member and said distal end, said handle is approximately co planar with said driving member, said handle is offset in relation to said extension member having a handle long extension and an opposing handle short extension, wherein said handle long extension is longer than said handle short extension such that said handle long extension is placed opposite of said driving member long extension in relation to said extension member; and
(e) a plant guide member positioned adjacent to said extension member and oriented substantially parallel to said axis, wherein said plant guide member is operational to help place the transplanted plant substantially within the void in the earth surface created by said open receptacle.

2. A hole coring apparatus according to claim 1 wherein said open receptacle surrounding sidewall is substantially elliptical in shape in a plane substantially perpendicular to said axis.

3. A hole coring apparatus according to claim 1 wherein said open receptacle surrounding sidewall is substantially circular in shape in a plane substantially perpendicular to said axis.

4. A hole coring apparatus according to claim 1 wherein said open receptacle surrounding sidewall is substantially square in shape in a plane substantially perpendicular to said axis.

5. A hole coring apparatus according to claim 1 wherein said open receptacle surrounding sidewall is substantially rectangular in shape in a plane substantially perpendicular to said axis.

6. A hole coring apparatus according to claim 1 wherein said handle is constructed of round tube stock.

7. A hole coring apparatus according to claim 1 wherein said extension member is constructed of angle iron.

8. A hole coring apparatus according to claim 7 wherein said driving member is constructed of angle iron.

9. A hole coring apparatus according to claim 1 wherein said driving member is positioned to be substantially co planar with said second open end, wherein said driving member is operational to limit penetration of said open receptacle into the earth surface by said driving member contacting the earth surface.

10. A hole coring apparatus according to claim 1 wherein said first open end perimeter is formed into a leading edge blade to ease penetration of said open receptacle into the earth surface.

11. A hole coring apparatus according to claim 1 wherein said plant guide member is in the form of an open ended chute including a first end portion adjacent to said extension member distal end and a second end portion adjacent to said extension member proximal end.

12. A hole coring apparatus according to claim 11 wherein said chute has a surrounding sidewall that defines a chute interior, wherein said chute surrounding sidewall is sized and configured to substantially match said open receptacle surrounding sidewall second open end perimeter.

13. A hole coring apparatus according to claim 12 wherein said chute first end portion terminates in an inlet and said chute second portion terminates in an outlet, wherein said chute inlet and outlet are sized and configured to substantially match said open receptacle surrounding sidewall second open end perimeter, wherein said inlet is operational to manually receive the transplanted plant with the transplanted plant proceeding through said chute interior by gravity and exiting said chute at said outlet to ultimately help place the transplanted plant substantially within the void in the earth surface created by said open receptacle.

14. A hole coring apparatus for creating a desired void in an earth surface to receive a transplanted plant, comprising:
(a) an open receptacle having a longitudinal axis, said open receptacle includes a surrounding sidewall positioned substantially symmetrical about said axis, said sidewall having a first open end and a second open end that are both substantially transverse to said axis to define a receptacle interior, said first open end having a perimeter that is less that a second open end perimeter;
(b) a plant guide member extending from a second end portion being adjacent to an exterior of said open receptacle sidewall to a first end portion, said plant guide member is in the form of an open ended chute, wherein said chute has a surrounding sidewall that defines a chute interior, said plant guide member is substantially parallel to said axis from said first end portion to said second end portion;
(c) a driving member adjacent to said plant guide member positioned substantially transverse to said axis near said receptacle, said driving member is offset in relation to said plant guide member having a driving member long extension and an opposing driving member short extension, wherein said driving member long extension is longer than said driving member short extension; and
(d) a handle adjacent to said plant guide member positioned substantially transverse to said axis located between said driving member and said first end portion, said handle is approximately co planar with said driving member, said handle is offset in relation to said plant guide member having a handle long extension and an opposing handle short extension, wherein said handle long extension is longer than said handle short extension such that said handle long extension is placed opposite of said driving member long extension in relation to said plant guide member, wherein said plant guide member is operational to help place the transplanted plant substantially within the void in the earth surface created by said open receptacle.

15. A hole coring apparatus according to claim 14 wherein said open receptacle surrounding sidewall is substantially elliptical in shape in a plane substantially perpendicular to said axis.

16. A hole coring apparatus according to claim 14 wherein said open receptacle surrounding sidewall is substantially circular in shape in a plane substantially perpendicular to said axis.

17. A hole coring apparatus according to claim 14 wherein said open receptacle surrounding sidewall is substantially square in shape in a plane substantially perpendicular to said axis.

18. A hole coring apparatus according to claim 14 wherein said open receptacle surrounding sidewall is substantially rectangular in shape in a plane substantially perpendicular to said axis.

19. A hole coring apparatus according to claim 14 wherein said handle is constructed of round tube stock.

20. A hole coring apparatus according to claim 14 wherein said driving member is constructed of angle iron.

21. A hole coring apparatus according to claim 14 wherein said driving member is positioned to be substantially co planar with said second open end, wherein said driving member is operational to limit penetration of said open receptacle into the earth surface by said driving member contacting the earth surface.

22. A hole coring apparatus according to claim 14 wherein said first open end perimeter is formed into a leading edge blade to ease penetration of said open receptacle into the earth surface.

23. A hole coring apparatus according to claim 14 wherein said chute surrounding sidewall is sized and configured to substantially match said open receptacle surrounding sidewall second open end perimeter.

24. A hole coring apparatus according to claim 23 wherein said chute first end portion terminates in an inlet and said chute second portion terminates in an outlet, wherein said chute inlet and outlet are sized and configured to substantially match said open receptacle surrounding sidewall second open end perimeter, wherein said inlet is operational to manually receive the transplanted plant with the transplanted plant proceeding through said chute interior by gravity and exiting said chute at said outlet to ultimately help place the transplanted plant substantially within the void in the earth surface created by said open receptacle.

25. A method for creating a desired void in an earth surface to receive a transplanted plant, with an operator manually using a hole coring apparatus, comprising the steps of:
(a) providing a hole coring apparatus that comprises an open receptacle with a longitudinal axis, a plant guide member extending from a second end portion being adjacent to said open receptacle to a first end portion, said plant guide member is substantially parallel to said axis, a driving member adjacent to said plant guide member positioned transverse to said axis near said receptacle, said driving member is offset in relation to said plant guide member including a driving member long extension and an opposing driving member short extension, and a handle adjacent to said plant guide member positioned substantially transverse to said axis located between said driving member and said first end portion, said handle is approximately co planar with said driving member, said handle is offset in relation to said plant guide member including a handle long extension and an opposing handle short extension, such that said handle long extension is placed opposite of said driving member long extension in relation to said plant guide member;
(b) positioning said open receptacle to a selected location on the earth surface where the desired void is to be located;
(c) placing a right foot of the operator upon said driving member long extension by bending a right knee of the operator, while leaving a left foot of the operator to remain on the earth surface by having a left leg extended of the operator wherein operator stability is enhanced;
(d) placing a left hand of the operator upon said handle long extension with a left arm of the operator extended;
(e) placing a right hand of the operator upon said short handle extension by bending a right arm elbow of the operator;
(f) applying a downward force by the operator simultaneously on the right foot of the operator upon said driving member long extension and a downward force on the left hand of the operator upon said handle long extension, wherein said open receptacle penetrates the earth surface with said axis being substantially perpendicular to the earth surface;
(g) continuing the downward force on the right foot and the left hand until said open receptacle penetrates the earth surface to a selected depth;
(h) removing said hole coring apparatus from the earth surface by applying an upward force on said handle from the left and right hands of the operator, wherein the desired void is created in the earth's surface such that a cored earth plug is substantially retained by said open receptacle;
(i) positioning said plant guide member to be substantially above said void in the earth's surface; and
(j) dropping the transplanted plant into said plant guide member to release the transplanted plant substantially into the void in the earth surface created by said open receptacle.

26. A method for creating a desired void in the earth surface according to claim 25 wherein said step of continuing the downward force is continued until said driving member contacts the earth surface.

27. A method for creating a desired void in the earth surface according to claim 25, wherein said step of continuing the downward force includes using both the right foot on said driving member long extension and the left foot on said driving member short extension, being operational to further increase the downward force.

28. A method for creating a desired void in an earth surface to receive a transplanted plant, with an operator manually using a hole coring apparatus, comprising the steps of:
(a) providing a hole coring apparatus that comprises an open receptacle with a longitudinal axis, a plant guide member extending from a second end portion being adjacent to said open receptacle to a first end portion, said plant guide member is substantially parallel to said axis, a driving member adjacent to said plant guide member positioned transverse to said axis near said receptacle, said driving member is offset in relation to said plant guide member including a driving member long extension and an opposing driving member short extension, and a handle adjacent to said plant guide member positioned substantially transverse to said axis located between said driving member and said first end portion, said handle is approximately co planar with said driving member, said handle is offset in relation to said plant guide member including a handle long extension and an opposing handle short extension, such that said handle long extension is placed opposite of said driving member long extension in relation to said plant guide member;
(b) positioning said open receptacle to a selected location on the earth surface where the desired void is to be located;
(c) placing a left foot of the operator upon said driving member long extension by bending a left knee of the operator, while leaving a right foot of the operator to remain on the earth surface by having a right leg extended of the operator wherein operator stability is enhanced;
(d) placing a right hand of the operator upon said handle long extension with a right arm of the operator extended;
(e) placing a left hand of the operator upon said short handle extension by bending a left arm elbow of the operator;
(f) applying a downward force by the operator simultaneously on the left foot of the operator upon said driving member long extension and a downward force on the right hand of the operator upon said handle long extension, wherein said open receptacle penetrates the earth surface with said axis being substantially perpendicular to the earth surface;
(g) continuing the downward force on the left foot and the right hand until said open receptacle penetrates the earth surface to a selected depth;
(h) removing said hole coring apparatus from the earth surface by applying an upward force on said handle from the left and right hands of the operator wherein the desired void is created in the earth's surface such that a cored earth plug is substantially retained by said open receptacle;
(i) positioning said plant guide member to be substantially above said void in the earth's surface; and
(j) dropping the transplanted plant into said plant guide member to release the transplanted plant substantially into the void in the earth surface created by said open receptacle.

29. A method for creating a desired void in an earth surface according to claim 28, wherein said step of continuing the downward force is continued until said driving member contacts the earth surface.

30. A method for creating a desired void in an earth surface according to claim 28, wherein said step of continuing the downward force includes using both the left foot on said driving member long extension and the right foot on said driving member short extension, being operational to further increase the downward force.
